(19) United States
(12) Patent Application Publication
(10) Pub. No.: US 2026/0271955 A1
(43) Pub. Date: Sep. 17, 2026

(54) PRODUCING CHEMICAL PRODUCTS ASSOCIATED WITH ENVIRONMENTAL ATTRIBUTES

(71) Applicant: BASF SE, Ludwigshafen am Rhein (DE)

(72) Inventors: Tara BADRI, Naples, FL (US); Marcelo Rocha LU, Singapore (SG); Elizabeth RAUDA SALAZAR, Ciudad de Mexico (MX); Areli GONZALEZ GASPAR, Ciudad de Mexico (MX); Henning SCHWABE, Mannheim (DE); Nicole GRAF, Ludwigshafen am Rhein (DE)

(21) Appl. No.: 19/503,320

(22) PCT Filed: Jun. 18, 2024
(86) PCT No.: PCT/EP2024/066906

§ 371 Date: Jan. 16, 2026

Related U.S. Application Data
(60) Provisional application No. 63/509,138, filed on Jun. 20, 2023.

(51) Int. Cl. A23D 9/02; C11B 3/02

(52) U.S. Cl. CPC A23D 9/02; C11B 3/02

(57) ABSTRACT

Disclosed are methods and systems for producing a chemical product associated with at least one environmental attribute. The environmental attribute may be associated with vegetable oil and may be attributed to the chemical product produced using the vegetable oil.

### TECHNICAL FIELD

The present disclosure relates to methods and systems for producing a chemical product associated with at least one environmental attribute. The environmental attribute may be associated with vegetable oil and may be attributed to the chemical product produced using the vegetable oil.

### TECHNICAL BACKGROUND

In supply chains the environmental impact of each supply chain participant is of great interest. Transparency between the participants as well as allocating the environmental impact on a flexible basis can aid collective reduction of environmental impacts to combat climate change. However, flexible allocation is hindered by the lack of common data standards and the lack of trusted data platforms. Hence, there is a need to allow flexible sharing of environmental attributes using a common data standard to broadly enable a flexible allocation of environmental attributes to chemical products.

### SUMMARY OF THE INVENTION

Disclosed is in one aspect a method for producing a chemical product associated with at least one environmental attribute, wherein the chemical product is produced by a chemical production using one or more vegetable oils(s) as input material, the method comprising:
receiving units of token(s) linked to one or more environmental attributes associated with the one or more of the vegetable oil(s) at an address associated with a distributed ledger, wherein the address is associated with the operating system of the chemical production;
producing the chemical product at least in part from the one or more vegetable oil(s) with the chemical production;
providing a chemical product identifier associated with the chemical product and optionally at least one target environmental attribute;
based on the chemical product identifier and optionally the target environmental attribute, selecting at least one attribution rule for attributing token(s) linked to one or more environmental attributes(s) associated with vegetable oil(s) to chemical product(s);
determining via the at least one attribution rule units of token(s) linked to one or more environmental attribute(s);
assigning the determined units of token(s) linked to the one or more environmental attribute(s) to the chemical product identifier;
providing the chemical product associated with the units of token(s).

Disclosed is in another aspect a system for producing a chemical product associated with at least one environmental attribute, the system comprising:
a chemical production configured to produce the chemical product using one or more vegetable oils(s) as input material and to provide the produced chemical product,
a distributed ledger application configured to receive units of token(s) linked to one or more environmental attributes associated with the one or more of the vegetable oil(s) at address associated with a distributed ledger, wherein the address is associated with the operating system of the chemical production,
an attribution module configured to provide at least one attribution rule for attributing token(s) linked to one or more environmental attributes(s) associated with vegetable oil(s) to chemical product(s);
a data provider configured to provide at least one chemical product identifier associated with the chemical product and optionally at least one target environmental attribute for the chemical product; and
an outbound allocator configured to
   select based on the chemical product identifier and optionally the target environmental attribute at least one attribution rule,
   determine via the at least one attribution rule units of token(s) linked to one or more environmental attribute(s), and
   assign units of at least one of the tokens linked to the one or more environmental attribute(s) to the chemical product identifier.

Disclosed is in yet another aspect a digital operating system of a chemical production, wherein the chemical production produces a chemical product using one or more vegetable oils(s) as input material, the digital operating system comprising:
a distributed ledger application configured to receive units of token(s) linked to one or more environmental attributes associated with the one or more of the vegetable oil(s) at address associated with a distributed ledger, wherein the address is associated with the operating system of the chemical production,
an attribution module configured to provide at least one attribution rule for attributing token(s) linked to one or more environmental attributes(s) associated with vegetable oil(s) to chemical product(s);
a data provider configured to provide at least one chemical product identifier associated with the chemical product and optionally at least one target environmental attribute for the chemical product; and
an outbound allocator configured to
   select based on the chemical product identifier and optionally the target environmental attribute at least one attribution rule,
   determine via the at least one attribution rule units of token(s) linked to one or more environmental attribute(s), and
   assign units of at least one of the tokens linked to the one or more environmental attribute(s) to the chemical product identifier.

Disclosed is in yet another aspect a computer element, in particular a computer program product or a computer readable medium, with instructions, which when executed by a processor cause the digital operation system as disclosed herein to perform the steps of:
receiving units of token(s) linked to one or more environmental attributes associated with the one or more of the vegetable oil(s) at address associated with a distributed ledger, wherein the address is associated with the operating system of the chemical production;
providing a chemical product identifier associated with a chemical product produced by a chemical production associated with the digital operation system using one or more vegetable oil(s) as input materials, and optionally at least one target environmental attribute;
based on the chemical product identifier and optionally the target environmental attribute, selecting at least one attribution rule for attributing token(s) linked to one or more environmental attributes(s) associated with vegetable oil(s) to chemical product(s);
determining via the at least one attribution rule units of token(s) linked to one or more environmental attribute(s);
assigning the determined units of token(s) linked to the one or more environmental attribute(s) to the chemical product identifier;
providing the chemical product associated with the units of token(s).

Disclosed is in yet another aspect the use of a chemical product associated with one or more environmental attribute(s) as provided by any of the methods disclosed herein and/or as produced by the systems disclosed herein to produce at least one discrete product or at least one end product of a product supply chain, wherein the at least one discrete product or the at least one end product is associated with the one or more environmental attribute(s).

Disclosed is in yet another aspect a method for producing at least one discrete product or at least one end product of a product supply chain associated with the one or more environmental attribute(s), wherein the chemical product associated with one or more environmental attribute(s) as provided by any of the methods disclosed herein and/or as produced by systems disclosed herein is provided and/or used to produce the at least one discrete product or at least one end product of a product supply chain associated with the one or more environmental attribute(s).

Any disclosure, embodiments and examples described herein relate to the methods, the systems, chemical products and computer elements lined out above and below. Advantageously, the benefits provided by any of the embodiments and examples equally apply to all other embodiments and examples.

### Embodiments

The methods, apparatuses, systems and computer elements disclosed herein provide an efficient way to flexibly allocate environmental attributes associated with vegetable oil(s) to chemical products produced at least in part from such vegetable oil(s) having a positive environmental impact. By converting environmental attributes of vegetable oil(s) to units of token(s), such environmental attributes can be flexibly shared among chemical product producers requiring such environmental attributes to adjust the produced chemical products to customer needs or to fulfil regulatory requirements. By using units of token(s) to reflect environmental attributes, the environmental attributes can be flexibly assigned to chemical products as required by customers and/or regulations irrespective of the environmental attributes associated with the vegetable oil(s) used to produce the chemical products, hence avoiding supply shortages due to shortages of vegetable oil(s) associated with the required environmental attributes. Hence, decoupling of environmental attributes from the physical flow of vegetable oil(s) within chemical productions allows to flexibly assign such attributes to products produced at least in part from such vegetable oil(s) if required, thus ensuring that chemical products can be tailored with respect to their environmental impact to customer's needs.

Additionally, the token units may be used to make the environmental attributes associated with the chemical product transparent to customers further processing the chemical products.

By using attribution rules, units of token(s) linked to environmental attributes associated with vegetable oil(s) and shared among chemical product producers can be efficiently attributed to chemical products. Specifically for chemical production networks that produce more than one chemical product from more than one vegetable oil via interconnected, connected and non-connected production chains, the use of attribution rules allows to reliably adjust the attribution mechanisms in line with the physical setup of the chemical production network. By providing a chemical product identifier associated with at least one target environmental attribute the environmental attributes to be allocated to the product and as such the number of token(s) and associated units attached to the chemical product may even be adjusted to customer needs.

By using token(s) and associated units linked (or assigned, attributed, allocated, attached) to a chemical product, customers can easily select sustainable products (e.g., products with renewable, bio-based, sustainable origin and/or a recycled content). They can use the token(s) and associated units to identify ways to make the value chain more sustainable. The token(s) also provide(s) a way for chemical production networks to speed the transformation of the use of sustainable feedstocks as input materials and the production of chemical products at least partly based on sustainable materials. Specifically for chemical networks that produce more than one chemical product from more than one vegetable oil via interconnected, connected and non-connected production chains, the use of token(s) enables the attribution of environmental attributes in line with the physical setup of the chemical production network. The use of token(s) enables the abstraction of the complexity of chemical production networks while still allowing to assign environmental impact to chemical products. This way the environmental impact of the produced chemical product(s) can be determined in line with the physical set up of the chemical production network. Moreover, the environmental property of the chemical products produced in the chemical production network can be made transparent to customers further processing the chemical products. By providing token(s) and associated units with a chemical product identifier associated with at least one target environmental attribute the environmental attributes may even be adjusted to customer needs.

The token may be a representation of environmental attribute(s) of a physical asset, such as vegetable oil(s) and/or chemical product, and can be exchanged among participants of a distributed ledger network and recorded in the distributed ledger. The participants of the distributed ledger network may at least in part correspond to participants of a product ecosystem including the chemical products. The token may be associated with units. Said units may specify a quantitative measure of the environmental attribute(s) the token is linked to, such as the amount of sustainable origin content of the chemical product. Said units may specify a quantitative measure of the environmental attribute(s) the token is linked to, such as the amount of sustainable origin vegetable oil entering the chemical production network. The token may specify a qualitative measure of the environmental attribute(s) the token is linked to, such as the sustainable origin of the vegetable oil(s). The token may be a fungible token (e.g. an asset that is not unique and mutually interchangeable). The token may be a nun-fungible token (e.g. an asset that is unique). This may allow to uniquely link a token and hence the environmental attribute(s) the token is associated with to a particular order of a produced chemical product.

The environmental attribute associated with the vegetable oil(s) may be a digital asset. The environmental attribute may digitally specify the environmental impact of the vegetable oil(s). The environmental attribute may relate to a sustainable origin of the vegetable oil(s). The environmental attribute may include a qualitative data point relating to the type of impact e.g., in view of the vegetable oil(s). The environmental attribute may specify a type such as sustainable origin. The qualitative data point may be converted to a quantitative measure such as token units. The environmental attribute may include a quantitate data point relating to the type of impact e.g., in view of the vegetable oil(s). The environmental attribute may specify a sustainable origin content. The environmental attribute may include further environmental characteristics of the vegetable oil(s).

Environmental attribute(s) may refer to any property or characteristic related to the environmental impact. Environmental attribute(s) may refer to certifications or certification data which document coherence to existing industry standards, in particular standards with respect to the environmental impact. Such property may be a property or characteristic of vegetable oil(s) and/or a chemical product(s). The environmental attribute may be derived from properties of the vegetable oil(s). The environmental attribute may be associated with the environmental impact of one or more material(s) at any stage during their lifecycle. The stages of the material or product lifecycle may include the stages of providing raw material, producing products, such as intermediate products or end products, using products, treating end-of-life products, recycling end-of-life products, disposing end-of-life products, reusing components from end-of-life products or any subset of stages. The environmental attribute may be tracked through any activity of one or more entities participating at any stage of the lifecycle of one or more material(s) or product(s). Environmental attributes associated with any activity of one or more entities participating at any stage of the lifecycle of one or more input material(s) or product(s) may be accumulated or aggregated.

The environmental attribute may include one or more characteristic(s) that are attributable to environmental or sustainability impact of the vegetable oil(s). The environmental attribute may include environmental or technical characteristics(s) associated with the environmental impact of the vegetable oil(s).

Environmental characteristic(s) may specify or quantify ecological criteria associated with the environmental impact of the vegetable oil, intermediate product, and/or a chemical product. Environmental characteristic(s) may be or may be produced or derived from measurements taken during the lifecycle of vegetable oil(s). Environmental characteristic(s) may for example include impact categories such as biotic and abiotic resource consumption, air emissions, stratospheric ozone depletion potential, ozone formation, terrestrial and/or marine acidification, water consumption, water depletion, water availability, water pollution, noise pollution, freshwater and/or marine eutrophication potential, terrestrial, freshwater and/or marine ecotoxicity, agricultural and/or urban land occupation, land transformation, land use, indirect land use, deforestation and/or biodiversity. Environmental characteristic(s) may be calculated from combinations of one of more environmental characteristics. Environmental characteristic(s) may for example include material or product characteristics related to the production of the material or product like produced using sustainable vegetable oil.

Technical characteristic(s) may specify or quantify material or product performance at least indirectly associated with the environmental impact. Technical characteristic(s) may for example include product composition data, bill of materials, product specification data, product component data, product safety data, application property data, application instructions or product quality data. Technical characteristic(s) may be or may be produced from measurements taken during the lifecycle of one or more material(s) or product(s). Technical characteristics may be determined at any stage of the material or product lifecycle and may characterize the material or product performance for such stage or up to such stage. Technical characteristic(s) may for example include composition data, input in the production process, bill of materials, product or material specification data, product or material component data, product or material safety data, application property data, application instructions or product or material quality data. Technical characteristic(s) may for example include physical, chemical or further properties of the material or product.

Chemical products may include or be any material produced by the chemical production network using at least one vegetable oil. The chemical product or output material may be produced from vegetable oil(s) by the chemical production network. The chemical product may be produced from the vegetable oil(s) via one or more chemical and/or physical processes. Hence, chemical intermediate products produced from vegetable oil(s) may be used to produce the chemical product(s) or output material(s). Chemical processes may include chemical reactions. Chemical reactions may include any chemical reaction commonly known in the state of the art in which the reactants are converted to one or more different chemical products. Chemical reactions may involve the use of catalysts, enzymes, bacteria, etc. to achieve the chemical reaction between the reactants. Physical processes may include mixing, separation and/or extrusion.

Chemical productions may include multiple types of production processes for producing different chemical products from vegetable oil(s). The chemical production may include a complex production network producing multiple chemical products in multiple production or value chains. A production or value chain may include one or more process(es) configured to produce one chemical product or chemical product class from one or more vegetable oil(s). The chemical production network may include connected, interconnected and/or non-connected production chains. The production chains included in the chemical production network may be defined by the physical system boundary of the chemical production network. The system boundary may be defined by location or control over production processes. The system boundary may be defined by the site of the chemical production network. The system boundary may be defined by production processes controlled by one entity or multiple entities jointly. The system boundary may be defined by the value chain with staggered production processes to an end product, which may be controlled by multiple entities jointly or separately. The chemical production network may include a production step to produce chemical products or intermediates from provided vegetable oil(s), a separation step to separate intermediates of one process step and further processing steps to convert such outputs to chemical product(s) leaving the system boundary of the chemical production network. The chemical production network may produce from vegetable oil(s) multiple intermediates and from intermediates one or more chemical products. Vegetable oil(s) may enter the chemical production network at entry points. Chemical products may leave the production network at exit points (or feed-out points).

The chemical production may comprise one or more entry points at which vegetable oil(s) are provided to the chemical production network. Input material may include conventional vegetable oil(s), non-conventional vegetable oil(s) or both. Non-conventional vegetable oil(s) may include vegetable oil(s) being associated with at least one environmental attribute. Conventional vegetable oil(s) may include vegetable oil(s) not being associated with at least one environmental attribute. Input material may include feedstock for a hydrolysis plant. Input material may include, for example sustainably produced vegetable oil (sustainable vegetable oil), such as sustainable palm oil, sustainable palm kernel oil, sustainable coconut oil, sustainable rapeseed oil, sustainable soybean oil or combinations thereof. Input material may be provided to at least one hydrolysis plant or any plant of the production chain for downstream products such as fatty acids, fatty alcohols, ethoxylated fatty acids, ethoxylated fatty alcohols, soaps or the like.

The vegetable oil associated with one or more environmental attribute(s) provided to the entry point of the chemical production may include vegetable oil(s) having a sustainable origin. The origin may refer to the geographical denomination that stands for the production and harvesting zone of the raw material (e.g. the plant used to produce the vegetable oil). The origin may be deemed sustainable if the origin of the vegetable oil(s) is deemed to comply with the established sustainability requirements for the respective vegetable oil(s). Such sustainability requirements may include biodiversity, carbon stock, peatland and/or land use change. Biodiversity requirements may include protection of primary forest and other (primary) wooded land, namely forest and other wooded land of native species, where there is no clearly visible indication of human activity and the ecological processes are not significantly disturbed. Biodiversity requirements may include protection of nature protection areas designated by law or by the relevant competent authorities for nature protection purposes. Biodiversity requirements may include protection of rare, threatened or endangered ecosystems or species recognized by international agreements, or included in lists drawn up by intergovernmental organizations or the International Union for Conservation of Nature (IUCN). Carbon Stock Requirement may include protection of wetlands, e.g. namely land that is covered with or saturated by water permanently or for a significant part of the year and/or continuously forested areas namely land spanning more than one hectare with trees higher than five meters and canopy cover of more than 30% or trees able to reach those thresholds in situ and/or lands spanning more than one hectare with trees higher than five meters and a canopy cover between a given range, or trees able to reach those thresholds in situ, unless evidence is provided. Peatland requirement may include that raw material intended for vegetable oil production shall not be made from land that was peatland in a specific earlier date. Land Use Change Requirement (LUC Requirement) may refer to the need of minimizing emissions of greenhouse gases caused by changes in land use since a particular year. Land use change should be understood as referring to changes in terms of land cover between the six land categories used by the IPCC (forest land, grassland, cropland, wetland, settlements and other land) plus a seventh category of perennial crop.,

The sustainable origin may be traceable by data, such as certificates, certifying the fulfillment of defined sustainability requirements. For example, the sustainable origin of the palm kernel oil and palm oil may be proven by an RSPO (round table on sustainable palm oil) certificate. The origin of the vegetable oil may be documented by storing data associated with the production of the vegetable oil(s), for example within a distributed ledger network. Steps in the production of the vegetable oil may include plantation, milling, crushing, transportation and refining. Data acquired for each step may be checked with respect to certain criteria to ensure that no fraudulent data is stored, and that the origin of the vegetable is documented correctly. Such data may be associated with the certificate to allow verification of the sustainable origin.

The chemical production may include identity preserving or segregated production chains. Identity preserving or segregated in this context may refer to the environmental attributes of the vegetable oil(s) being preserved or segregated in the production chains. Examples are vegetable oil(s) having a sustainable origin used to produce the chemical product with sustainable origin content. Further examples are vegetable oil(s) having a non-sustainable origin used to produce the chemical products with non-sustainable origin content. Chemical productions may include non-identity preserving or non-segregated production chains. Non-identity preserving or non-segregated in this context may refer to vegetable oil(s) associated with environmental attributes being mixed. For example, non-identity preserving or non-segregated in this context refers to vegetable oil(s) associated with environmental attributes being mixed with conventional vegetable oil(s) in the production chains. Examples are vegetable oil(s) having sustainable and non-sustainable origin being mixed to produce the chemical product with sustainable and non-sustainable origin content.

The distributed ledger network may be a peer-to-peer network with a plurality of nodes. Each node may comprise a peer-to-peer application in the form of a decentralized ledger. Each node may comprise a peer-to-peer application in the form of a shared database. Each node may comprise the same peer-to-peer application. The decentralized ledger may be configured to store data, e.g. tokens and associated units, transfers of token units, creation of tokens and associated units, burning of token units, etc., with certain proofs or signatures. The decentralized ledger may further be configured to store computer code in the form of executable means. In particular, an executable means can be invoked by a transaction to the (unique) communication address of the executable means in so called ‘smart contracts’. This executable means may be processed on the plurality of node(s) of the peer-to-peer network. That executable means (e.g. smart contracts) or processing logic may be stored and executed in so called ‘crypto conditions’ of the Interledger protocol (ILP) such that not necessarily all code of an executable means need be stored in a smart contract such as Ethereum smart contract. Alternatively, the executable means (smart contract) may be stored and executed on a decentral computation market (e.g. Ethereum Computation Market, Trubit, Golem, Cryplets Microsoft).

The decentralized ledger or shared database may be readable by participating entities (participants), such as any entity of a product ecosystem including raw material manufacturers, chemical product manufacturers, part manufacturers, assembly manufacturers, end-product manufacturers, end-product users, end-of-life product collectors and recyclers, of the peer-to-peer network. The decentralized ledger or shared database may be readable at least by a part of the participants of the peer-to-peer network. The decentralized register, at least the public part (i.e. may be without private contracts) may be read at least by each participant of the peer-to-peer network. Peer-to-peer network nodes may send messages to or write messages to the peer-to-peer application. A message or transaction sent to an executable means may start the execution of a code of the executable means while using data (transaction criterions and/or other data) stored in the executable means. For instance, sending transaction data indicating generation of new units of a previously generated token to such executable means may result in generation (e.g. minting) of further units of such a token.

Information among peer-nodes may be exchanged by a peer-to-peer messaging system. This means a peer node may send a message to another peer node to submit an information or to trigger an action. Messages may be clear text, signed, hashed, time-stamped and/or encrypted. This means that not all data exchanged among peer nodes need be stored on the decentralized register.

The peer-to-peer application might be built upon the following elements: peer-to-peer network comprising Consensus System/Protocol, Data Structure, Merkle Trees, Public Key Signatures and/or Byzantine Fault Tolerance. It may replicate data based on a consensus principle. It may be auditable and traceable. The peer-to-peer application may be a decentralized ledger comprising at least two blocks coupled to each other (e.g. a block chain). The block chain may be a decentralized, peer-to-peer-based register in which tokens linked to environmental attribute(s) may be created, transferred and burned (e.g. transferred to an address not being associated with a private key). The block chain may be a permissionless block chain. The block chain may be permissioned. The block chain may be public. The blockchain may be a consortium block chain. The block chain may be a private block chain. Alternatively, the peer-to-peer application may be formed by multiple block chains which are connected via mechanisms, such as side chains or smart contracts. A peer-to-peer node may run one or more different block chain client(s). Data of the peer-to-peer application may be stored on the “decentral ledger technology”. The decentralized ledger may steer (encrypted) data storage accessible via the internet, such as in decentral data storage, object store and database (e.g. Interplanetary File System (IPFS) or storj), or in a distributed Blockchain database (e.g. BigChainDB). Access to encrypted data by third party entities may be managed via an access means formed as one or more smart contract(s) on the block chain.

The transaction data may be generated and sent to the distributed ledger network via a peer-to-peer module. The peer-to-peer module may provide an interface module, such as an application programming interface (API), and a decentral application for communication with the computer nodes of the peer-to-peer network or the peer-to-peer application, such as a block chain or a smart contract on the block chain, e.g. the peer-to-peer module may not comprise the peer-to-peer application and may not be a node of the peer-to-peer network. This allows reducing the required processing power of the peer-to-peer module. For instance, such a peer-to-peer module can either send clear text or encrypted information or generate a secure connection (e.g. tunnel) to a peer-to-peer gateway (or so called “remote node”) in order to communicate with the peer-to-peer network. The decentral application of software may comprise local algorithms at least configured to create and transmit data, such as the transaction data, to the peer-to-peer application via the API. The decentral application (so called “Dapp”) is at least configured to generate and transmit said data. For instance, the peer-to-peer module might be a so called “light node” or a decentral application (DAPP) connected to a remote node. Data and messages may be signed or encrypted. Data and messages may be transmitted via a cryptographically secured tunnel or a secured internet connection to a peer-to-peer node running the peer-to-peer application, such as the block chain. To securely deploy an executable means and or data into a device a trusted execution environment, such as Intel SGX or TPM or Direct Anonymous Attestation module, may be integrated with a peer-to-peer module.

Alternatively, the peer-to-peer module may be a peer-to-peer node comprising at least a part of the peer-to-peer application. For instance, the peer-to-peer module may comprise the total data content of the peer-to-peer application. The peer-to-peer module may comprise the decentral application, the API and the peer-to-peer application, such as the block chain or decentral ledger.

The peer-to-peer network may comprise one or more validating peers or full node(s). Such validating nodes may be configured to perform a validation process, e.g. creating new entries in the distributed ledger or shared database. The peer-to-peer network node may further comprise one or more observing nodes. The observing nodes may be configured to validate transactions to establish a trust level but does not validate all transactions which is done by the validating peer. The peer-to-peer network may comprise one or more mining nodes. Such mining nodes may participant in the proof-of-work consensus algorithm. Such mining nodes may append new blocks to the blockchain upon solving the mathematical problem associated with the proof-of-work algorithm.

Data stored on the distributed ledger may be stored in clear text. Data stored on the distributed ledger may be encrypted and the keys may be handled via the distributed ledger. Transactions of units of tokens may be stored in clear text on the block chain. Privacy preserving, secure transactions or execution of computer code may be achieved with cryptographic tools, such as zero knowledge (zk) proofs or zk Succinct Non-interactive Arguments (zk-SNARK). Transactions or algorithms may be separated into two parts: an executable means (e.g. a smart contract) on the distributed ledger and a further executable means (e.g. a private contract). A privacy preserving protocol may ensure the privacy of data and the correctness of code execution (SNARK verification may be done via the smart contract on chain). The private contract computation may be done by a set of nodes, off-chain computers or done in measured launch environment or a secure hardware enclave for attestation and sealing that cannot be manipulated by other software code running on the devices. Alternatively, secure Multi-Party-Computing (sMPC) systems may be used for transactional privacy. Examples for privacy preserving protocols and computation include HAWK and MIT Enigma. Use of zero knowledge proof (zk Proofs) allows to verify that the algorithm is executed correctly in a private contract without disclosing the input data to the verifying party. zk Proofs may be stored in and/or validated by the peer-to-peer application. In addition, selective privacy may be achieved by sharing keys to decrypt transactions for reporting and auditing purposes.

The chemical product may be produced by the chemical production network to which the input material(s) associated with one or more environmental attribute(s) were provided. The chemical product may be produced by a production chain of the chemical production network to which the input material(s) associated with one or more environmental attribute(s) were provided. The chemical product may be produced from the input material(s) associated with one or more environmental attribute(s).

The chemical product may include one or more identifier(s) relating to the chemical product. The identifier may relate to a chemical product class, a specific chemical product and/or properties of the chemical product such as environmental properties. The identifier may include a unique number uniquely associated with the chemical product class, the specific chemical product and/or the properties of the chemical product. The identifier may include one or more specific identifier(s), such as chemical product class identifier, specific chemical product identifier and/or property of the chemical product identifier. Such specific identifier(s) may be uniquely linked to the chemical product. For example, one or more property identifier(s) may be uniquely linked to the chemical product identifier. The chemical product identifier may be uniquely linked to the specific chemical product. This way the chemical product can be uniquely linked to a digital twin of the chemical product specifying specific properties of the chemical product.

The chemical product identifier may include one or more identifier(s) relating to one or more environmental attribute(s). The identifier may include an environmental attribute identifier, such as a unique environmental attribute identifier, relating to environmental attribute(s) assignable to chemical products. The environmental attribute identifier may relate to the chemical product class or the specific chemical product. For example, the environmental attribute identifier may relate to sustainable origin as environmental attribute having its own unique material identifier. The specific environmental attribute or a specific combination of environmental attributes may be related to the unique environmental attribute identifier.

The chemical product identifier may include, be linked to or be related to a batch and/or order number, such as a unique batch and/or order number. The batch number may be linked to the physical entity of produced chemical product batches. The order number may be linked to the transaction specifying the shipment of the chemical product batch from the producer of the chemical product to the user further processing the chemical product.

The chemical product identifier may be associated with a product specification for the chemical product.

In an embodiment, the vegetable oil may be selected from palm oil, palm kernel oil, coconut oil or combinations thereof. Palm oil and palm kernel oil may be produced from the fruit of the palm oil tree. Palm oil may be produced by milling the fruits of the palm oil tree. Palm kernel oil may be produced by crushing the palm kernels. The sustainable origin of the vegetable oil may be associated with its production. In particular, the sustainable origin may be associated with the growth of the plants used to produce the vegetable oil.

In an embodiment, the environmental attribute associated with the vegetable oil(s) is associated with production data of the vegetable oil. Production data may include data associated with the growth of the plants used to produce the vegetable oil, data associated with the harvesting of the plants used to produce the vegetable oil, data associated with the transport of harvested plants or parts thereof, data associated with the processing of the harvested plants or parts thereof, data associated with the refining of vegetable oil, or a combination thereof. Data associated with the growth of the plants may include origin data associated with the origin of the plants used to produce the vegetable oil. The origin may refer to the geographical denomination that stands for the production and harvesting zone of the plant used to produce the vegetable oil. Data associated with the processing may include data associated with milling and/or crushing processes of harvested plants or parts thereof. At least part of the production data may be stored on a distributed ledger network. Such data may include data on the geographic location of the growth of plants used to produce the vegetable oil. Such data may include data on the harvesting of such plants. Such data may include data on the transport of such harvested plants or parts thereof to a mill. Such data may include data on the treatment of the harvested plants or parts thereof, such as data on milling process, data on crushing process and/or data on a refinery process. Prior to storing such data on the distributed ledger network, such data may be validated. This may ensure that only correct data is stored on the distributed ledger network, hence avoiding storage of incorrect data which may be used for incorrect certification afterwards. For instance, data relating to a sustainable origin may be checked with respect to location data associated with the growth of the plants prior to storing a sustainable origin for such plants and vegetable oils produced therefrom.

In an embodiment, the environmental attribute is associated with or corresponds to certificate data being indicative of a production of the vegetable oil according to predefined production criteria. Predefined production criteria may include different areas of impact of the vegetable oil production. Such areas may be defined by different data points, such as data points associated with prosperity, people and nature. Data points associated with prosperity may include data on ethical and transparent behavior, data on legal operation and respecting of rights. Data points associated with people may include data associated with respect of human rights and community, data on support of smallholder inclusion, data on respect of workers' rights and conditions. Data points associated with nature may include data on protection of ecosystems and environment. Predefined production criteria may include the above-mentioned biodiversity, carbon stock, peatland and/or land use change.

In an embodiment, the units of token(s) are received in response to a request, said request including the address and the units of token(s). The request may be provided to an entity owning units of such token(s). The entity may be operating a platform allowing token owners to transfer unused units of token(s) linked to environmental attributes associated with vegetable oil(s) to an address associated with said entity operating said platform. The token owners may be chemical product producers producing chemical products using vegetable oil(s) associated with environmental attribute(s). The address may be associated with the operating system of the chemical production producing the chemical product. Receiving units of token(s) linked to environmental attributes associated with vegetable oil(s) allows chemical product producers to allocate such units of token(s) and hence the linked environmental attributes to chemical products produced at least in part from vegetable oil(s) not being associated with the required environmental attributes. Hence, requesting units of token(s) linked to required environmental attribute(s) may allow to customize chemical products to needs of the customer without having to source the feedstock being associated with the required feedstock. This allows a flexible assignment of environmental attributes within the product ecosystem, avoiding supply shortages and allowing to fulfill customer needs by flexibly allocating environmental attributes from one chemical product producer to further chemical product producers.

In an embodiment, the received units of token(s) are created upon use of vegetable oil(s) associated with the environmental attribute(s) within a different chemical production to produce chemical product(s) and are not assigned to a chemical product produced by said different chemical production. The received units of token(s) may be created by a chemical product producer based on vegetable oil(s) associated with environmental attribute(s) and used as input materials for the associated chemical production network. The received units of the token(s) may be created upon entry of the vegetable oil(s) to the chemical production network. The received units of the token(s) may be created based on vegetable oil data associated with the vegetable oil. The vegetable oil data may include the production data of the vegetable oil mentioned previously.

The vegetable oil data may include a measured or determined physical and/or chemical property of the vegetable oil, data associated with the delivery of the vegetable oil, a vegetable oil identifier, a LOT number, a batch number, certificate data or a combination thereof. The vegetable oil identifier may comprise any identifier uniquely associated with the vegetable oil. The vegetable oil may relate to one specific physical entity of the vegetable oil such as a batch or a packaged material. The vegetable oil may relate to a group of physical entities of the vegetable oil such as batches or packaged material produced from one production chain or site, such as a production chain or site included in the chemical production. The vegetable oil identifier may be associated with continuous or semi-continuous stream of vegetable oil fed to the chemical production. The vegetable oil identifier may refer to a stream of the vegetable oil, e.g. over a certain time period or from a certain supplier, fed to the chemical production. The LOT number may be assigned to the inbound material on production of said materials. The LOT number may refer to an identification number assigned to a particular quantity or lot of vegetable oil from a single manufacturer. LOT numbers can typically be found on the outside of the packaging of the vegetable oil. The order number may be assigned to the transfer of a certain physical entity, quantity or group of vegetable oil(s) to the chemical production network. The order number may be assigned to the vegetable oil transfer. The order number may relate to the vegetable oil producer identity and the entity operating the chemical production network. The certificate data may include the certificate type, the allocation scheme, the environmental attribute, the quantity of vegetable oil associated with the environmental attribute, the amount of vegetable oil, the producer identifier, vegetable oil identifier or combinations thereof. The certificate may be generated by a certifying authority and may indicate that the vegetable oil fulfils the requirements associated with said certificate. For example, the certificate may certify at least one environmental attribute of the inbound material, such as its sustainable origin.

The vegetable oil data may be provided via a physical identifier attached to the physical entity of the vegetable oil. The physical identifier may include a code, such as a bar code, a QR code, an embossed code, an RFID tag, a marker, etc. The physical identifier may be associated with a decentral identifier. The decentral identifier may comprise any unique identifier uniquely associated with the input material(s).

The decentral identifier may include a Universally Unique IDentifier (UUID) or a Digital IDentifier (DID). The decentral identifier may be issued by a central or decentral identity issuer. The decentral identifier may be linked to authentication and/or authorization information. Via the decentral identifier and its unique association with the vegetable oil producer and vegetable oil data, access to the vegetable oil data may be controlled by the vegetable oil producer. This contrasts with central authority schemes, where identifiers are provided by such central authority and access to data is controlled by such central authority. Decentral in this context refers to the usage of the identifier in implementation as controlled by the data owner, such as the input material producer.

The vegetable oil suppliers and the chemical product producer may be part of a product ecosystem. The product ecosystem may include different stages including manufacturing, use and re-use. In these stages one or more ecosystem participant(s) may contribute to the manufacture, use or re-use of the product. For example, the manufacturing stage may include raw material manufacturers, chemical product manufactures and/or end-product manufacturers. Further for example, the use stage may include a product user, product maintainers and/or product distributors. Further for example, the re-use stage may include collectors, sorters, dismantlers, recyclers, restorers and/or re-furbishers.

The participants of the product ecosystem may be connected via a decentral network. The decentral network may include computing nodes associated with participants of the product ecosystem and may be configured to perform data transactions. The computing nodes associated with participants of the product ecosystem may be associated with producers, users or re-users of physical products, such as input material producers, chemical product producers, intermediate product producers, end product producers, end product users, used product users or product re-users. The data transactions may be based on a transaction protocol including authentication and/or authorization mechanism(s). Based on the authentication and/or authorization mechanism(s) a peer-to-peer communication between computing nodes associated with participants of the product ecosystem may be established. The chemical product manufacturer may access vegetable oil data via a decentral data consuming network node configured to access data at a decentral data providing network node based on decentral identifiers. For instance, the decentral data consuming network node may access vegetable oil data at a decentral data providing network node associated with the vegetable oil producer. The vegetable oil data may be accessed upon or after entry of the vegetable oil to the chemical production network. The vegetable oil data may be stored on a dedicated storage associated with the decentral data providing network node. The dedicated storage and hence access to the vegetable oil data may be under control of the vegetable oil data owner, such as the vegetable oil producer.

The vegetable oil data may be used to determine the environmental attributes associated with the vegetable oil. Determining environmental attributes may comprise determining the amount of the vegetable oil. In case more than one vegetable oil is provided, the amount of at least part of the provided vegetable oils may be determined. The determination may be based on a bill of materials, a sales receipt, a recipe and/or any of a wide range of digital documents (e.g., vegetable oil data) associated with receipt of vegetable oil(s). An operating system may parse the vegetable oil data to determine the amount of vegetable oil that was received. The “amount” of the vegetable oil may refer to the volume, amount of substance, and/or mass of the vegetable oil. The amount of vegetable oil entering the chemical production network may be stored in one or more vegetable oil storages, such as tanks and/or warehouses. The vegetable oil storage(s) may be connected to one or more production plants of the chemical production network, for example via pipes allowing continuous or batch-wise supply of vegetable oil to the respective plant.

The environmental attributes associated with the vegetable oil may be determined via a virtual production process. Virtual production may refer to receiving vegetable oil data for a sustainable vegetable oil and producing environmental attributes (based on the sustainable vegetable oil) and also generating conventional vegetable oil data (e.g., data describing the corresponding amount and/or value of the conventional vegetable oil). The virtual production process may be performed by a virtual production module configured to receive vegetable oil data associated with the at least one vegetable oil and to produce environmental attributes associated with the at least one vegetable oil. The virtual production module may further be configured to determine an amount of the vegetable oil. The virtual production module may further be configured to determine a value associated with the vegetable oil.

The determined environmental attributes may be used to create one or more token(s) linked to at least one determined environmental attributes. The token(s) may be created by generated transaction data and providing the transaction data to the distributed ledger network. The transaction data may include a new token object that defines a token name, a token description, a token symbol, the number of decimals to which each unit of the token can be sub-divided, an initial quantity (e.g. initial units) of the token, an address associated with the operating system and token control function(s) defining one or more functions of the token, such as minting functions, burning functions, transfer functions, approve functions and/or balancing functions. The new token object may be generated based on existing token templates. The token templates may include templates corresponding to (1) fungible assets (i.e., assets that are not unique and mutually interchangeable) with variable supply, (2) fungible assets with fixed supply, (3) non-fungible assets (i.e., assets that are unique) with variable supply, and (4) non-fungible assets with fixed supply. The token templates may include control functions. Use of a token template to generate the transaction data may simplify the token creation process and ensures that the generated token(s) contain all required token control functions to allow desired handling of the token. The transaction data may include a first address associated with the operating system, a second address associated with the operating system and units of token(s) to be transferred. The transaction data may be provided to the distributed ledger network as previously described. Upon execution of the transaction, the quantity of the token specified in the transaction data is transferred from the first address to the second or further address. Hence, the balance of the first address decreased by the quantity specified in the transaction data while the balance of the second address increases by the same quantity. This allows to transfer previously minted units of a token to a further address.

Generating transaction data may include determining the units of token based on the determined environmental attributes. The units of token may be determined based on a rule set. The rule set may define correlations between a vegetable oil, an environmental attribute of the vegetable oil, an amount of the vegetable oil and the associated units of a token. The input material may be identified in the rule set via the input material identifier. The environmental attribute may be identified via an environmental attribute identifier. The rule set may include correlations for several input materials and/or for several environmental attributes and/or for several amounts of input material. For instance, the rule set may define that a predefined amount, such as a kilogram or a ton, of a predefined vegetable oil, such as palm oil, associated with a predefined environmental attribute, such as sustainable origin, may represent defined units of the token “sustainable origin”. The rule set may define correlations between environmental unit(s) associated with a defined amount of vegetable oil and the units of the token. The rule set may define rules to determine the environmental unit(s) from the determined environmental attributes. For instance, the rule set may define rules to convert a determined environmental attribute to said environmental unit(s) based on the amount of vegetable oil provided to the chemical production network.

Part of the created units of token(s) may be linked to chemical products to associate said chemical products with the environmental attributes linked to the token(s). Unused units of token(s) (e.g. token units not being associated with produced chemical products) may be transferred by the chemical product producer having created the units of token(s) to a platform such that other chemical product producers requiring such environmental attributes may receive units of token(s) linked to such environmental attributes. This allows flexible sharing of environmental attributes within the chemical product production, hence avoiding supply shortages of chemical products associated with environmental attributes.

By converting the environmental attribute(s) of vegetable oil to units of token(s), said token(s) may act as a digital environmental currency and may be used to share the environmental attribute(s) within chemical product producers. The digital environmental currency may allow to decouple the material flow of the vegetable oil(s) through the chemical production network from the environmental attributes associated with said vegetable oil and may allow to allocate such environmental attributes to chemical products produced by said chemical production network fully or at least partially independent of material flows. Hence, the token(s) may be balanced independent from the physical flow of vegetable oil(s) used during production of chemical product(s) by the chemical production network. The token(s) linked to the respective environmental attribute(s) may be balanced based on the system boundary of the chemical production network. The token(s) linked to the respective environmental attribute(s) may be balanced based on the vegetable oil(s) entering the system boundary of the chemical production network and the produced chemical product(s) exiting the chemical production network. Unused units of token(s) may be shared with other chemical product producers as previously described.

In an embodiment, the token(s) relate to or is/are associated with one or more characteristic(s) of the vegetable oil associated with one or more environmental attribute(s). The token(s) may relate to one or more characteristic(s) of the vegetable oil that are attributable to environmental impact of the vegetable oil and the chemical product produced by the chemical production. The characteristic(s) of the vegetable oil may include, and may not be limited to, an input material type, an origin type, an allocation scheme, or combinations thereof. By specifying the characteristics of the vegetable oil, the environmental attribute and characteristics of vegetable oils used to produce the chemical product may be tracked with more granularity. This enables a system to track the environmental attributes and characteristics of the vegetable oil more granularly. More granular tracking via the token(s) in return enables allocation of units of token(s) linked to environmental attributes to chemical products that are tailored to customer needs.

In an embodiment, the token(s) relate(s) to or is/are associated with a vegetable oil type, an origin type, an allocation scheme, or combinations thereof. The virtual balancing system or the token(s) may be associated with metadata specifying the vegetable oil associated with one or more environmental attribute(s). The metadata may specify the vegetable oil associated with one or more environmental attribute(s) provided to the entry point of the chemical production network. The vegetable oil type may include, and may not be limited to, vegetable oil, palm oil, palm kernel oil, coconut oil, or combinations thereof. Chemicals may include, but may not be limited to, fatty acids, fatty alcohols or combinations thereof.

In an embodiment, the token(s) may be associated with metadata specifying a vegetable oil type, an origin type, an allocation scheme, or combinations thereof. As one example, sustainable palm oil and/or palm kernel oil may be provided to the chemical production network as vegetable oil. The metadata may specify the vegetable oil type palm oil/palm kernel oil, the environmental attribute type sustainable origin and/or the allocation scheme non-segregated scheme such as mass balance.

In an embodiment, the token(s) is/are associated with vegetable oil types, sustainable palm oil, sustainable palm kernel oil or sustainable coconut oil. In an embodiment, the token(s) is/are associated with a hydrolysis of the vegetable oil.

In an embodiment, the token(s) is/are associated with metadata specifying the relationship between the vegetable oil(s) associated with one or more environmental attribute(s) and the chemical product. In another embodiment the relationship relates to the chemical production network, one or more production chain(s), one or more chemical product(s), one or more chemical product classes or combinations thereof. The relationship may relate to the chemical production network. For example, the input material(s) associated with one or more environmental attribute(s) may be provided to the chemical production network producing the chemical product. The relationship may relate to one or more production chain(s) of the chemical production network producing the chemical product. For example, the vegetable oil(s) associated with one or more environmental attribute(s) may be provided to one or more production chain(s) of the chemical production network producing the chemical product. The relationship may relate to one or more chemical product class(es) produced by the chemical production network. For example, the vegetable oil(s) associated with one or more environmental attribute(s) may be provided to one or more production chain(s) of the chemical production network producing the chemical product class(es). The relationship may relate to one or more chemical product(s) produced by the chemical production network. For example, the vegetable oil(s) associated with one or more environmental attribute(s) may be provided to one or more production chain(s) of the chemical production producing the one or more chemical product. The relationship may relate to the chemical production network, one or more production chain(s), one or more chemical product(s), one or more chemical product classes or combinations thereof. By tagging with the relationship metadata the vegetable oils may be physically and/or chemically traceable. The metadata may be derived from a digital twin of the chemical production network (or a portion of the chemical production network). The metadata may be derived from a digital twin of the chemical production network (or a portion thereof) and a production schedule.

In an embodiment, the environmental attributes associated with the one or more of the vegetable oil(s) are decoupled from the physical flow of vegetable oil(s) within the chemical production. Decoupling of the environmental attribute(s) via the unit(s) of tokens from the physical flow of vegetable oil(s) within the chemical production allows to flexibly assign such environmental attribute(s) to chemical product(s) produced from such vegetable oil(s) irrespective of the environmental attribute(s) associated with the particular vegetable oil(s) used for the production of a particular product. This way, environmental attribute(s) can be assigned in line with target environmental data provided by customers of the chemical product irrespective of the environmental attribute(s) associated with the vegetable oil(s) supplied to the chemical production. By flexible allocation of environmental attribute(s) to chemical product(s), the environmental attribute(s) can be more efficiently allocated, since allocation is more independent of the supply of vegetable oil(s) associated with environmental attribute(s) requested by the customer(s).

In an embodiment, the target environmental attribute may relate to or be associated with a sustainable origin content. The target environmental attribute may further be related to or associated with metadata specifying a vegetable oil type, an origin type, an allocation scheme, or combinations thereof. Based on such metadata, the metadata associated with or related to the token(s) may be matched, and addresses holding matching token(s) may be selected. The units of matching token(s) may be transferred from the selected addresses, for example as described later on. The transferred units may be assigned to the chemical product, for example as described later on. Owing to the token(s) and associated metadata granular target environmental attributes can be achieved.

The chemical product identifier and target environmental attribute may be provided in response to receiving data related to an order associated with the chemical product. The order data may be received from a chemical product consumer. Order data may include an indication that the chemical product should be associated with at least one environmental attribute. The chemical product identifier may be provided based on the order data. Triggering provision of the chemical product identifier and target environmental attributes allows to assign environmental attributes via units of tokens linked to said attributes to the produced chemical product if requested by a customer, thus ensuring that the produced chemical product fulfils the needs of the customer with respect to environmental attributes while avoiding an automatic assignment process of environmental attributes based on input materials used to produce the respective chemical products. This allows to provide chemical products being associated with the required environmental attribute(s) while maintaining a flexible supply of input materials and production of the chemical products based on available input material(s).

In an embodiment, the at least one attribution rule specifies the allocation scheme associated with the address. The at least one attribution rule may specify the attribution of environmental attributes associated with vegetable oil(s) to environmental attributes associated with chemical products. The at least one attribution rule may depend on a chemical product identifier and an environmental attribute. The at least one attribution rule may include instructions for attributing environmental attributes via token(s) and associated units to at least one address associated with the operating system. The at least one attribution rule may include instructions for transferring units of token(s) linked to environmental attributes from at least one address. The at least one attribution rule may include instructions for linking units of tokens linked to environmental attribute(s) to chemical products or chemical product identifiers. Such linking may comprise transfer of said units of token(s) from the address such that the balance of the address is reduced by the transferred units. This ensures that units of token(s) and hence environmental attributes allocated to a produced chemical product are no longer available in the virtual accounting system, hence ensuring that the received environmental attributes represented by the units of token(s) are only used once for assignment to the chemical product

The at least one attribution rule may be associated with environmental attribute types that relate to certified or non-certified environmental attributes. The at least one attribution rule may be associated with environmental attribute types that relate to input material dependent environmental attributes. The at least one attribution rule may be associated with environmental attribute types that relate to chemical network or production chain dependent environmental attributes. The at least one attribution rule may be associated with environmental attribute types that relate to chemical product dependent environmental attributes. The at least one attribution rule may be associated with environmental attribute types that relate to environmental attributes certified under specific certification schemes. The at least one attribution rule may be associated with environmental attribute types that relate to environmental attributes adhering to specific attribution schemes.

The at least one attribution rule may be associated with at least one attribution scheme specifying the balancing or environmental attributes. The at least one attribution rule may be associated with at least one segregated or non-segregated attribution scheme. The at least one attribution rule may be associated with at least one non-segregated attribution scheme. The at least one attribution rule may be associated with one or more non-segregated attribution schemes, such as a mass balance scheme with free attribution, a mass balance scheme without free attribution or a book-and-claim scheme.

In an embodiment, the at least one attribution rule is associated with vegetable oil(s) characterized by at least one environmental attribute type. The at least one attribution rule may be associated with vegetable oil(s) entering the chemical production. The at least one attribution rule may be associated with vegetable oil(s) used to produce one or more chemical product(s).

The at least one attribution rule may be associated with at least one chemical product characterized by at least one environmental attribute type. The at least one attribution rule may be associated with at least one chemical product type exiting the chemical production. The at least one attribution rule may be associated with at least one chemical product type produced from one or more vegetable oil(s).

The at least one attribution rule may be associated with token(s). The at least one attribution rule may be associated with environmental attribute types.

The token(s) and the at least one attribution rule may be associated at least in part with corresponding metadata. The token(s) and the at least one attribution rule may be associated with corresponding metadata. The token(s) and the at least one attribution rule may be associated with partially corresponding metadata. The set of metadata associated with a token and the at least one attribution rule may match in all data points of the meta data. The set of metadata associated with a token and the at least one attribution rule may relate to at least one environmental attribute type, at least one chemical production network, at least one production chain, at least one attribution scheme, at least one input material type, at least one chemical product type or combinations thereof. The input material type may relate to characteristics of the vegetable oil, such as sustainable-origin vegetable oil. The input material type may relate to sustainable origin vegetable oil for input to a hydrolysis plant. The input material type may relate to the geographic origin of the vegetable oil. The input material type may relate to the production process of the vegetable oil, such as refined or unrefined vegetable oil.

The attribution rule may include instructions to determine one or more address(es) accessible (e.g. usable for transferring units of token(s)) for the at least one chemical product. The at least one attribution rule may include instructions to determine one or more address(es) accessible for the at least one chemical product and/or the units of token(s) accessible for the at least one chemical product. The attribution rule may be associated with metadata signifying the one or more address(es) accessible for the at least one chemical product. The attribution rule may include instructions to verify or validate the one or more address(es) accessible for the at least one chemical product. The attribution rule may include instructions to determine, verify and/or validate the one or more address(es) accessible for the at least one chemical product. For determination of the one or more address(es) accessible for the at least one chemical product, the attribution rule may be associated with the chemical product or chemical product type.

In an embodiment, the at least one attribution rule includes instructions to determine the input material(s) used to produce the chemical product. The attribution rule may include instructions to access a bill of material comprising vegetable oil data, chemical product data and process data. From the bill of material, the environmental attribute types and hence the units of token(s) accessible for the at least one chemical product may be determined. From the environmental attribute types, the one or more address(es) accessible for the at least one chemical product may be determined.

The attribution rule may include instructions to match the metadata of the token(s) with the chemical product type corresponding to the chemical product. For determination of the one or more address(es) accessible for the at least one chemical product, the attribution rule may be associated with the production chain. The attribution rule may include instructions to match the metadata of the token(s) with the production chain. Such metadata matching may be executed for any combination of metadata associated to the token(s) and attribution rules as lined out above.

For verification of the one or more address(es) accessible for the at least one chemical product, the attribution rule may be associated with the chemical product type and one or more address(es). On verification the one or more address(es) accessible for the at least one chemical product may be determined and compared to the one or more address(es) associated with the attribution rule. For verification of the one or more address(es) accessible for the at least one chemical product, the attribution rule may be associated with the chemical product type and one or more token(s). On verification the one or more address(es) holding token(s) accessible for the at least one chemical product may be determined and compared to the one or more token(s) associated with the attribution rule.

For validation of the one or more address(es) accessible for the at least one chemical product, the attribution rule may be associated with the chemical product type and one or more address(es). For validation of the one or more address(es) accessible for the at least one chemical product, the attribution rule may be associated with the chemical product type and one or more token(s). On validation the metadata and/or the balance of the one or more address(es) accessible for the at least one chemical product may be checked to be validly accessible.

In an embodiment, assigning determined units of token(s) to the chemical product identifier comprises generating transaction data and providing the generated transaction data to a distributed ledger for creating one or more further token(s) specifying the retired units of the token(s), the one or more environmental attributes linked to the token(s) and the provided chemical product identifier. Retired units of token(s) may refer to units which are no longer accessible for the chemical product producer for allocation to produced chemical products. For instance, such units may be transferred to an address not associated with, e.g. not being under control of, the chemical production/operating system/entity operating the chemical production. The address may be associated with a third party creating the one or more further token(s). Transfer of said token units may include generating transaction data specifying the address the units are to be transferred to, the units to be transferred and the provided chemical product identifier. The transaction data may be generated by a decentral application. The decentral application may be configured to provide the generated transaction data to a distributed ledger network. Creating one or more further token(s) may include generating transaction data specifying the retired units of token(s), the one or more environmental attributes linked to token(s) associated with the retired units and the provided chemical product identifier and providing the generated transaction data to the distributed ledger network for creating the one or more further token(s). The transaction data may be generated by the operating system. The transaction data may be generated by a third party on behalf of the entity operating the chemical production network.

The one or more further token(s) may specify a value associated with the input material, wherein the value associated with the input material is related to a difference in cost between the input material and a corresponding amount of fossil input material. The value may be provided in the transaction data

The one or more further token(s) may uniquely specify the chemical product with the combination of the chemical product identifier, the one or more environmental attributes and retired units of the token(s). Hence, the one or more further token(s) may be non-fungible token(s) uniquely specifying the chemical product via the chemical product identifier.

The one or more further token(s) may specify or be associated with metadata. The one or more further token(s) may contain a digital representation pointing to the metadata or parts thereof. This allows to store metadata of the token(s) off chain, hence allowing to update or change the metadata without having to burn and mint another token. For instance, the one or more non-fungible tokens may include a link pointing to an off-chain storage location of the meta data.

The one or more further token(s) may be created at an address associated with the chemical production. The one or more further token(s) may be created at an address associated with a third party and may be transferred to an address of the chemical production. Upon transfer of the chemical product associated with said one or more token(s) to a chemical product consumer, the one or more token(s) may be transferred to an address (e.g. address associated with the distributed ledger network) associated with the chemical product consumer.

In another embodiment, assigning determined units of token(s) to the chemical product identifier comprises transferring the determined units to a further address associated with the distributed ledger network, the further address being associated with the provided chemical product identifier. The further address may further be associated with the operating system of the chemical production. For instance, further addresses may be associated with metadata indicating the provided chemical product identifier and such metadata may be used to determine the further address. The further address may further be associated with the recipient of the produced chemical product.

In yet another embodiment, assigning determined units of token(s) to the chemical product identifier comprises locking the determined units by transferring said units to a vault address associated with the distributed ledger network, wherein the determined units are transferred by generating transaction data including the determined units and locking data associated with the chemical product identifier and sending the transaction data to the distributed ledger network to lock the determined units, and wherein the locked units can be unlocked and transferred from said vault address using the locking data. The vault address corresponds to an executable means which may be invoked by sending the transaction to said (unique) communication address of the executable means. The transaction allows to look the determined units token(s) using a secret. The secret may, for example, be a hash value of the chemical product identifier. The produced chemical product associated with said chemical product identifier may be provided to a consumer. The chemical product may be associated with a physical identifier having encoded a decentral identifier. The decentral identifier may be used to access chemical product data from a decentral data providing network node of the chemical product producer as described previously. The chemical product data may include the secret used to look the units of token(s). The chemical product consumer may use the secret to generate transaction data including the secret and the vault address and may provide the transaction data to the distributed ledger network for unlocking the units (e.g. transferring said units to an address of the distributed ledger network associated with the chemical product consumer).

In an embodiment, assigning the determined units of token(s) to the chemical product identifier includes,
checking the balance of addresses holding token(s) associated with the determined token units and assigning the determined units of token(s) from the associated address to the chemical product identifier if the balance is sufficient, and/or
checking that the respective token(s) are associated with input material(s) used to produce the chemical product and assigning the determined units of token(s) from addresses holding said units to the chemical product identifier if the respective token(s) is/are associated with vegetable oil(s) used in the production chain of the chemical product.

Vegetable oil(s) used to produce the chemical product may include vegetable oil(s) associated with environmental attributes at the entry to the chemical production network. Input material(s) used to produce the chemical product may include vegetable oil(s) associated with environmental attribute(s) and vegetable oil(s) not associated with environmental attribute(s). The respective environmental attributes may be decoupled from the material flow by generating token(s) and associated units.

Assignment of determined units of token(s) to the chemical product identifier may be performed prior to, during or after production of the chemical product. Creation prior to production ensures that the environmental attributes requested by a customer can be associated with the produced chemical product. Moreover, this allows to determine the remaining units of token(s) and hence environmental attributes available for allocation to produced chemical products independent from the production, hence ensuring that customer needs with respect to environmental attributes associated with an ordered product can be fulfilled.

### BRIEF DESCRIPTION OF THE DRAWINGS

In the following, the present disclosure is further described with reference to the enclosed figures. The same reference numbers in the drawings and this disclosure are intended to refer to the same or like elements, components, and/or parts.

FIG. 1 illustrates an example of a transfer of units of token(s) linked to environmental attributes associated with vegetable oil(s) within a product ecosystem.

FIG. 2 illustrates an example of a chemical production network producing one or more chemical product(s) from one or more input material(s) in connection with an operating system including an attribute management system.

FIG. 3 illustrates a virtual production system for producing sustainable chemical products by decoupling the environmental attributes of incoming sustainable inputs and producing balancing units.

FIG. 4A illustrates a merger system for producing sustainable chemical products involving the use of non-fungible tokens.

FIG. 4B illustrates a merger system for producing sustainable chemical products involving the use of addresses associated with environmental attributes.

FIG. 4C illustrates a merger system for producing sustainable chemical products involving the use of a vault address to look and unlock units of tokens linked to environmental attributes.

FIG. 5 illustrates an example of the converting environmental attributes associated with vegetable oil(s) to token units and assignment to chemical products.

FIG. 6 illustrates an exemplary supply chain of palm oil and palm kernel oil.

FIG. 7 illustrates an example of a chemical production with different allocation schemes.

FIG. 8A illustrates a first example of a participant network of a product ecosystem associated with a decentral peer-to-peer network for exchange of vegetable oil data associated with vegetable oil(s) to create units of token(s) linked to environmental attributes associated with the vegetable oil(s).

FIG. 8B illustrates an exchange of vegetable oil data associated with vegetable oil provided to a chemical production network via a decentral peer-to-peer network.

FIG. 9 illustrates an example of a method for producing a chemical product associated with at least one environmental attribute.

FIG. 10 illustrates an example of a system for producing at least one chemical product associated with one or more environmental attribute(s) including an example method for assigning at least one environmental attribute to the at least one produced chemical product.

FIG. 11A illustrates an example of a participant network of a product ecosystem associated with a decentral peer-to-peer network for exchange of environmental attributes associated with vegetable oil(s) used as input materials to produce chemical product(s).

FIG. 11B illustrates a transfer of token units linked to environmental attribute(s) associated with vegetable oil(s) from a first chemical product producer via a platform to a second chemical product producer.

FIG. 11C illustrates an exchange of token(s) linked to environmental attributes and being associated with a chemical product provided by the chemical production network to a chemical product consumer via a decentral peer-to-peer network.

### DETAILED DESCRIPTION

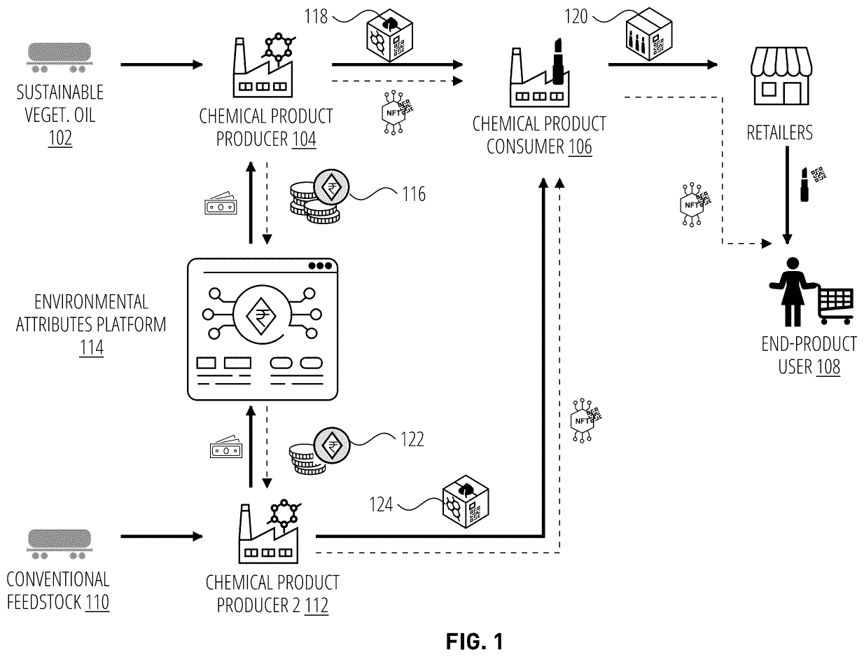

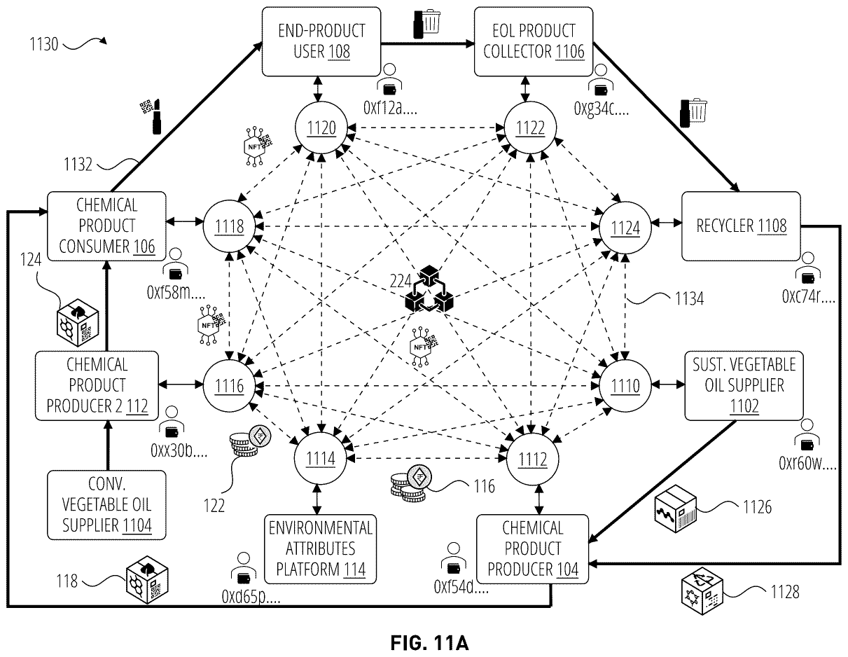

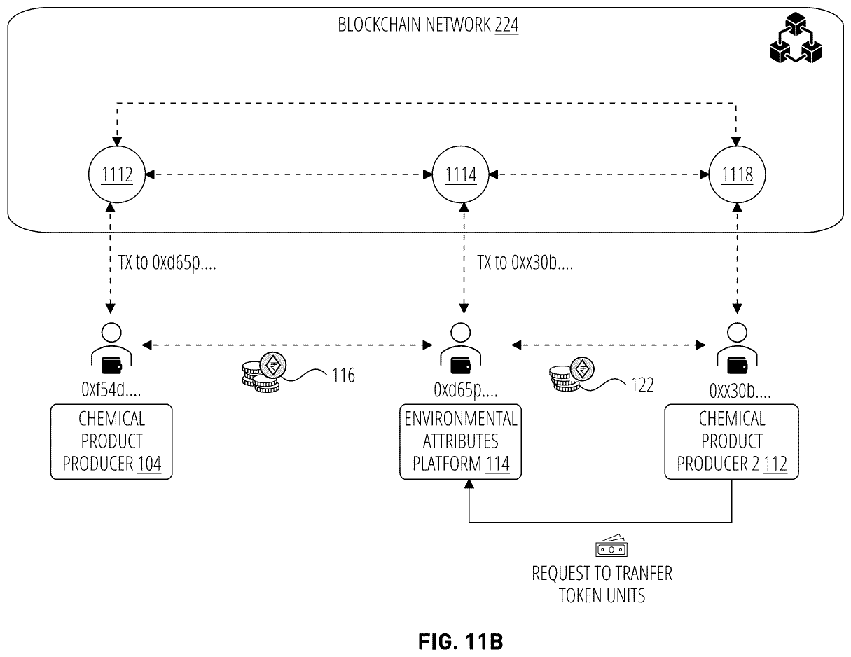

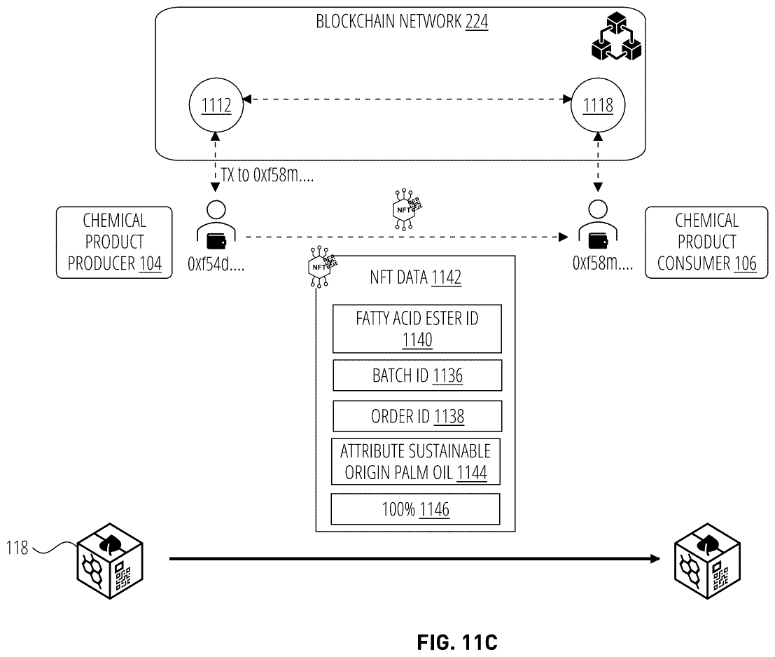

FIG. 1 illustrates an example of a transfer of units of token(s) linked to environmental attributes associated with vegetable oil(s) within a product ecosystem. The product ecosystem may involve the production of end-products. The product ecosystem may further involve recycling processes associated with the recycling of the used end-product (not shown, see for example FIG. 11A).

Chemical product producer 104 may produce chemical product(s) from vegetable oil(s) associated with one or more environmental attribute(s). The vegetable oil(s) may include palm oil, palm kernel oil and/or coconut oil. Exemplary chemical product(s) produced from such vegetable oil(s) may include fatty acids. Exemplary chemical product(s) produced from such vegetable oil(s) may include fatty alcohols. Exemplary chemical product(s) produced from such vegetable oil(s) may include ethoxylated fatty acids and/or ethoxylated fatty alcohols. Exemplary chemical product(s) produced from such vegetable oil(s) may include anionic surfactants, such as ethoxylated anionic surfactants. Exemplary chemical product(s) produced from such vegetable oil(s) may include fatty acid esters and/or fatty alcohol esters. Exemplary chemical product(s) produced from such vegetable oil(s) may include soaps.

The environmental attribute(s) may be associated with production data of the vegetable oil. Production data may include data associated with the growth of the plants used to produce the vegetable oil, data associated with the harvesting of the plants used to produce the vegetable oil, data associated with the transport of harvested plants or parts thereof, data associated with the processing of the harvested plants or parts thereof, data associated with the refining of vegetable oil, or a combination thereof. Data associated with the growth of the plants may include origin data associated with the origin of the plants used to produce the vegetable oil. The origin may refer to the geographical denomination that stands for the production and harvesting zone of the plant used to produce the vegetable oil. Data associated with the processing may include data associated with milling and/or crushing processes of harvested plants or parts thereof. At least part of the production data may be stored on a distributed ledger network. Such data may include data on the geographic location of the growth of plants used to produce the vegetable oil. Such data may include data on the harvesting of such plants. Such data may include data on the transport of such harvested plants or parts thereof to a mill. Such data may include data on the treatment of the harvested plants or parts thereof, such as data on milling process, data on crushing process and/or data on a refinery process. Prior to storing such data on the distributed ledger network, such data may be validated. This may ensure that only correct data is stored on the distributed ledger network, hence avoiding storage of incorrect data which may be used for incorrect certification afterwards. For instance, data relating to a sustainable origin may be checked with respect to location data associated with the growth of the plants prior to storing a sustainable origin for such plants and vegetable oils produced therefrom.

The environmental attribute may be associated with or correspond to certificate data being indicative of a production of the vegetable oil according to predefined production criteria. The predefined production criteria may relate to the plantation of the vegetable from which the vegetable oil is produced. The predefined production criteria may relate to the transport of the harvested vegetable and/or the vegetable oil. The production criteria may relate to the production of the vegetable oil from the harvested vegetable. The production criteria may relate to the refinement of crude vegetable oil. The predefined production criteria may relate to biodiversity, carbon stock, peatland and/or land use change as previously described.

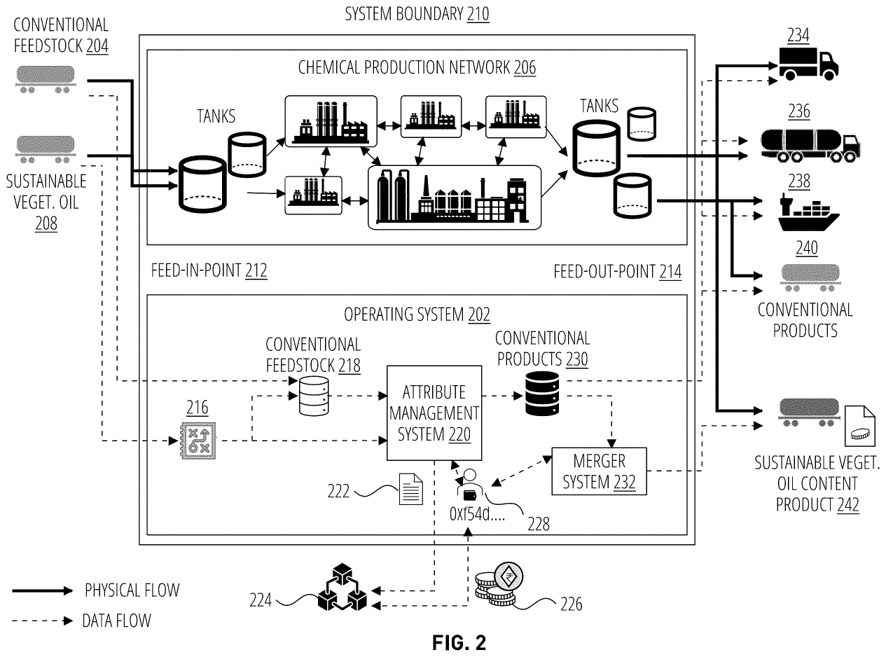

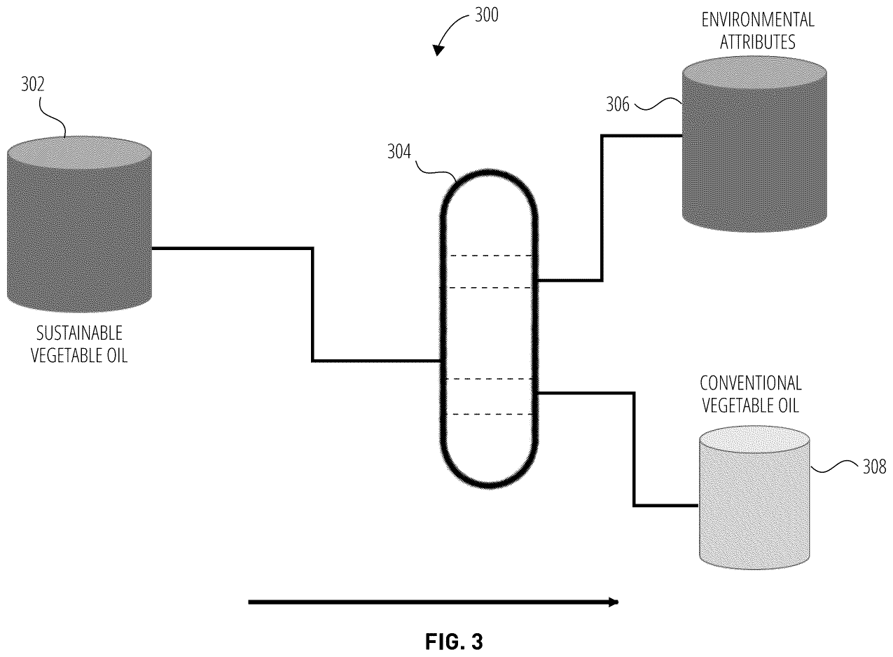

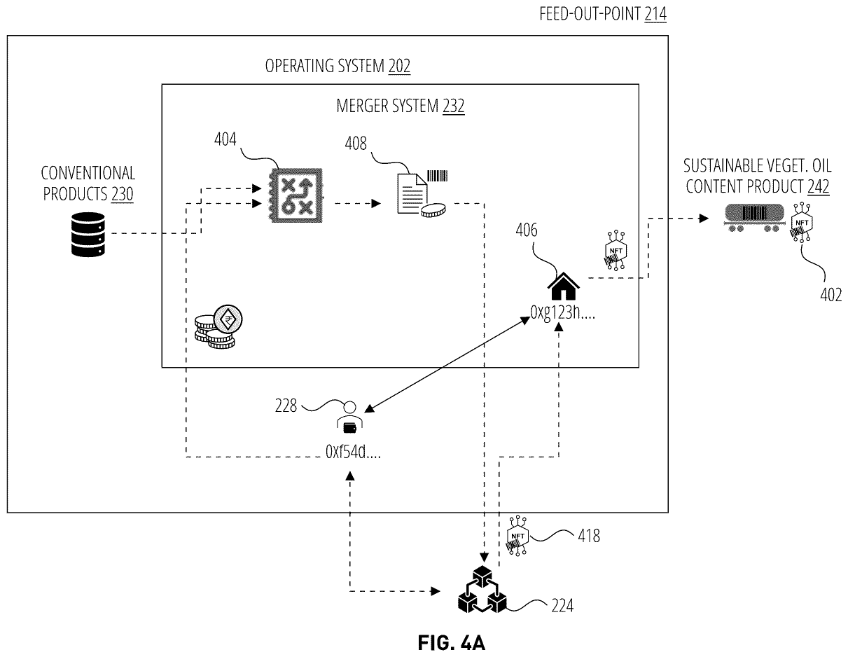

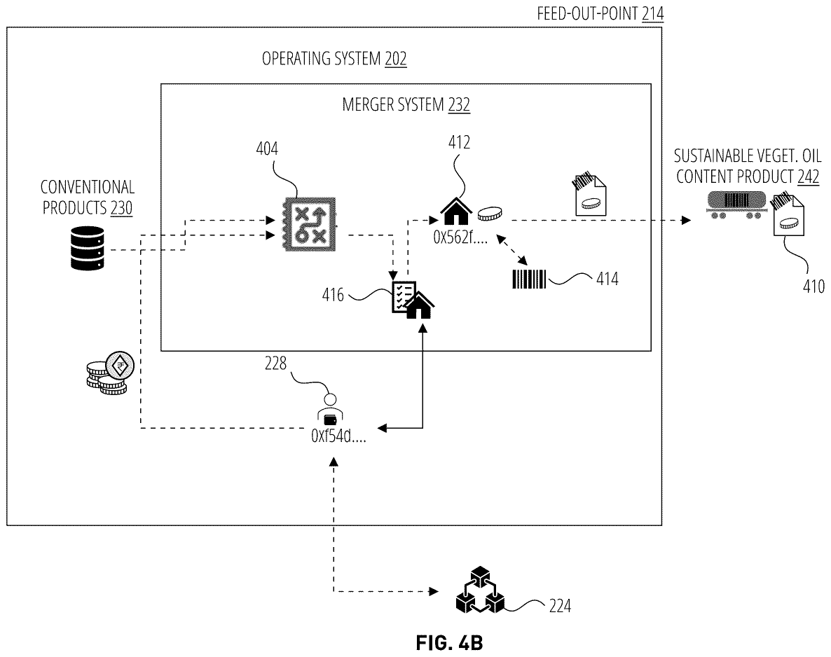

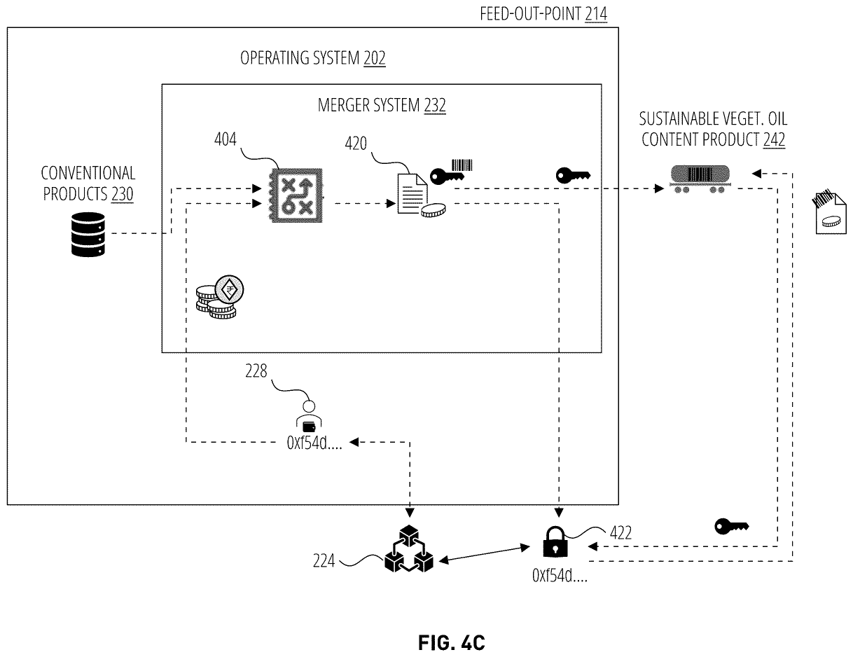

Chemical product producer 104 may create unit(s) of token(s) linked to environmental attributes associated with vegetable oil(s) 102 entering the chemical product of chemical product producer 104. The units(s) of token(s) may be created as described in the context of FIG. 2 and FIG. 3. Chemical product producer 104 may assign created unit(s) of token(s) to produced chemical product(s) 118. Assignment of created units of token(s) may be performed as described in the context of FIG. 4A to FIG. 4C. Chemical product producer 104 may transfer the chemical product 118 and associated units of token(s) (illustrated as non-fungible token in FIG. 1) to chemical product consumer 106. The token units may be transferred as illustrated in FIG. 11C.

Chemical product consumer 106 may produce one or more end-products, such as cosmetic goods, using the chemical product(s) received from chemical product producer 104. Consumer goods may include cosmetic products. Cosmetic products may include shower gels, shampoo, creams, lipsticks, deodorants, antiperspirants or the like. Chemical product consumer 106 may assign the environmental attributes associated with the chemical product(s) received from chemical product producer 104 and optionally environmental attributes associated with further input material to the produced end-product, for example using the method described in the context of FIG. 2. The produced end-product 120 may be provided to end-product user 108 via retailers. The assigned environmental attributes may be retrieved by end-product user 108 for example from a distributed ledger network based on the chemical product identifier associated with the produced end-product.

Chemical product producer 104 may not assign all created unit(s) of tokens to chemical products produced from vegetable oil(s) associated with environmental attribute(s) 102. Chemical product producer 104 may transfer at least part of the “remaining” (e.g. unassigned or unused) units of token(s) 116 to an address of a distributed ledger network associated with environmental attributes platform 114. In return, chemical product producer 104 may obtain fiat currency or cryptocurrency. Environmental attributes platform 114 may serve as a platform to trade remaining units of token(s) 116 and may be configured to display available units of token(s) and associated token metadata. Token metadata may include the environmental attributes linked to the respective token.

Chemical product producer 2 112 may produce one or more chemical product(s) from vegetable oil(s) not being associated with environmental attribute(s) 110 (hereinafter denoted as conventional feedstock). However, chemical product producer 2 112 may desire to associate such produced chemical products with one or more environmental attributes linked to vegetable oil(s). Hence, chemical product producer 2 112 may acquire units of token(s) 122 at environmental attributes platform 114. Chemical product producer 2 112 may assign the acquired units of token(s) to the produced chemical product, for example as described in the context of FIG. 4A to FIG. 4C. The chemical product associated with the environmental attribute(s) 124 may be provided to chemical product consumer 106.

Tokenization of environmental attribute(s) associated with vegetable oil(s) allows to separate such environmental attributes from the material flow through the chemical production on entry of the vegetable oil(s) hence allowing to flexibly assign the separated environmental attributes to chemical product(s) produced using such vegetable oil(s) and to adjust assignment of environmental attributes to customer needs. Unassigned tokenized environmental attributes may be provided to further chemical product producers requiring such environmental attributes to fulfill customer needs such that supply shortcomings of sustainable chemical product(s) may be avoided. Hence, the use of sustainable vegetable oils within a product ecosystem may be improved since allocation of tokenized environmental attributes may be performed more efficiently by providing unused tokenized attributes to other participants of the product ecosystem for production of chemical products containing sustainable vegetable oil content.

FIG. 2 illustrates an example of a chemical production network 206 producing one or more chemical product(s) from one or more vegetable oil(s) in connection with an operating system 202 including an attribute management system 220 to manage environmental attributes associated with at least part of the vegetable oil(s). For producing one or more chemical product(s) different input materials (feedstocks) may be provided as physical inputs from material providers or suppliers. The input material may include a vegetable oil associated with an environmental attribute, such as a sustainable origin, 208. The input material may include a conventional vegetable oil 204 (e.g. a vegetable oil not being associated with environmental attributes) for the manufacture of chemical intermediates and chemical products. The chemical products 242 produced at last in part from the vegetable oil(s) may have one or more properties related to the environmental impact of the vegetable oil(s), that may be signified by the environmental attributes.

The chemical production network 206 may include multiple interlinked processing steps. The chemical production network 206 may be an integrated chemical production network with connected or interconnected production chains. The chemical production network 104 may include multiple different production chains that have at least one intermediate product in common. The chemical production network 206 may include multiple stages of the chemical value chain. The chemical production network 206 may include the refining, processing and/or purification of vegetable oil. The chemical production network 206 may include a hydrolysis plant connected to multiple production chains that output chemical products from the effluent of the hydrolysis plant. The chemical production network 206 may include multiple production chains that produce from one or more vegetable oil(s) chemical products that exit the chemical production network 206. The chemical production network 206 may include multiple tiers of a chemical value chain. The chemical production network 206 may include physically connected or interconnected supply chains and/or production sites. The production sites may be at the same location or at different locations. In the latter case, the production sites may be connected or interconnected by means of dedicated transportation systems such as pipelines, supply chain vehicles, like trucks, ships or other cargo transportation means.

The chemical production network 206 may chemically convert input materials, such as vegetable oil(s), via chemical intermediates to one or more chemical product(s) that exit the chemical production network. The chemical production network 206 may convert the input material(s) by way of chemical conversion to one or more chemical product(s).

The input material(s) may be fed into the chemical production network 206 at any entry point. The input material(s) may be fed into the chemical production network 206 at the start of the chemical production network 206. Input materials may for example make up the feedstock of a hydrolysis plant.

The chemical production network 206 may include multiple production steps. The production steps included in the chemical production network 104 may be defined by the system boundary of the chemical production network 206. The system boundary may be defined by location or control over production processes. The system boundary may be defined by the site of the chemical production network 206. The system boundary may be defined by production processes controlled by one entity or multiple entities jointly. The system boundary may be defined by a value chain with staggered production processes to an end product, which may be controlled by multiple entities separately. The chemical production network 206 may include a hydrolysis step, a separation step to separate outputs of one process step and further processing steps to convert such outputs to a chemical product leaving the system boundary of the chemical production network 206.

The chemical production network 206 may be associated with an operating system 202. Operating system 202 may be a digital operating system configured to collect, store, manage and interpret a wide range of production and/or business data for chemical production network 206. Operating system 202 may be part of an Enterprise Resource Planning (ERP) system. Alternatively, operating system 202 may be partly implemented in an ERP system and partly implemented in one or more additional systems coupled with an ERP system. Operating system 202 may also be implemented in one or more systems outside of an ERP system.

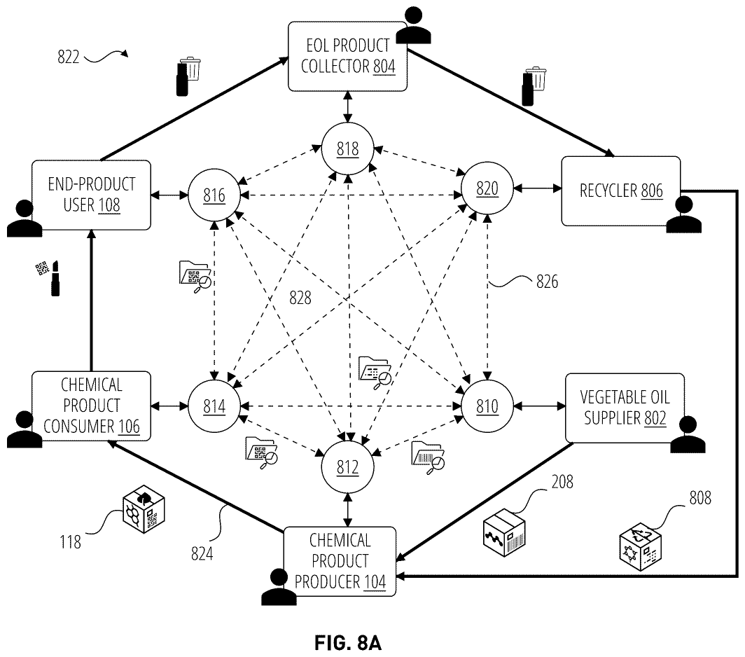

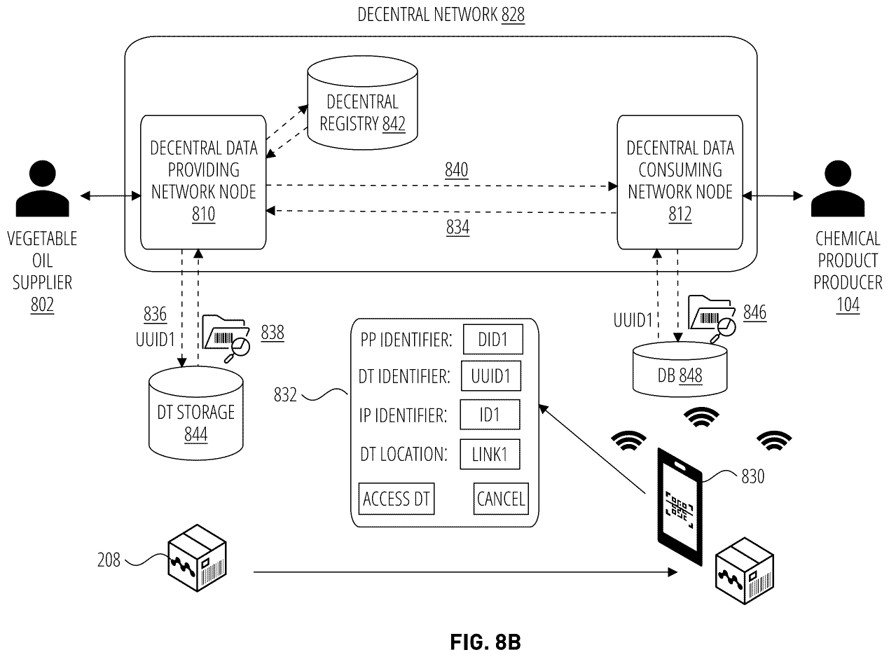

Input materials 204, 208 may be provided to chemical production network 206 at the feed-in-point 212. The input materials may include conventional feedstock 204 (e.g. conventional vegetable oil) as well as vegetable oil associated with environmental attribute(s) 208. The vegetable oil associated with environmental attribute(s) 208 may include vegetable oil(s) having a sustainable origin (e.g. sustainable palm oil, sustainable palm kernel oil, sustainable coconut oil). After they are delivered to chemical production network 206, the conventional input materials 204 and the sustainable input materials 208 may be combined (e.g., by being fed into the same tank) as they enter the chemical production process. Input material data for sustainable input material 208 may be provided to operating system 202 at 216. For example, the goods receipt (and/or a BOM and/or a chemical production recipe) including the vegetable oil data for each of the sustainable vegetable oil may be electronically provided to operating system 202 when sustainable materials 208 are delivered to chemical production network 206. Operating system 202 may receive vegetable oil data 216 through an interface to a local or a remote database or an ERP system, in particular its supply chain module, or any computing system or apparatus, such as a centralized or decentralized computing system or apparatus including processing and storage. Operating system 202 may receive vegetable oil data via a decentral network, such as described in the context of FIG. 8A and FIG. 8B. The input material data for each input material may hence be gathered from an ERP system or any computing system or apparatus, such as a centralized or decentralized computing system or apparatus including processing and storage. In some cases, the input material data of each input material is gathered through an interface to more than one database. It therefore may be necessary to convert the information retrieved from different databases into a single format to allow further processing. In particular, the input material data obtained from databases may be attributed to the input material via the identification of an input material in the database that has to be translated to the identification of the input material of the process data used in the process according to the present disclosure.

Operating system 202 may initiate a virtual production step after it receives the vegetable oil data for sustainable materials 208. Virtual production may refer to receiving vegetable oil data for a sustainable vegetable oils and producing environmental attributes (based on the sustainable vegetable oil) and also generating conventional vegetable oil data (e.g., data describing the corresponding amount and/or value of the conventional vegetable oil).

For example, with reference to FIG. 2 and FIG. 3, operating system 202 may initiate virtual production process 300 when it receives vegetable oil data for sustainable input material(s) (e.g., 216). Using vegetable oil data 216, virtual production process 300 may parse the vegetable oil data and apply a corresponding recipe. For example, virtual production process 300 may determine the volume (or mass) and type of sustainable vegetable oil that was received from the vegetable oil data. It may then apply virtual production step(s) 304 to the sustainable vegetable oil 302. Virtual production step(s) 304 may “produce” or generate both environmental attributes 306 and conventional vegetable oil 308. The amount of conventional vegetable oil 308 (virtually) generated may be equal to the amount of sustainable vegetable oil 302. Referring again to FIG. 2, after the virtual production process, operating system 202 may credit digital inventory (which may also be referred to as a virtual balancing account) 218 with the amount of conventional feedstock that was created by the virtual production process(es).

Operating system 202 may determine the amount (e.g., volume and/or mass) and the value of sustainable vegetable oil 208. For example, operating system 202 may parse vegetable oil data 216 to determine the amount of sustainable vegetable oil 208 that was received. Operating system 202 may then provide such data to attribute management system 220.

Attribute management system 220 may determine token units based on the environmental attributes, such as the sustainable origin of the vegetable oil. For instance, attribute management system 220 may determine token units based on a rule set correlating the environmental attributes to token units. Attribute management system 220 may convert the environmental attributes to balancing units. Attribute management system 220 may determine token units based on the balancing units. Balancing units may be determined based on a conversion factor. The conversion factor may be associated with the amount of vegetable oil.

For instance, attribute management system 220 may determine token units based on a rule set correlating balancing units to token units. Attribute management system 220 may generate transaction data 222 and provide the generated transaction data 222 to a distributed ledger network 224, such as distributed ledger network 224 described in the context of FIG. 4A to FIG. 4C and FIG. 11A. The transaction data may include a new token object that defines a token name, a token description, a token symbol, the number of decimals to which each unit of the token can be sub-divided, an initial quantity (e.g. initial units) of the token, an address associated with the operating system and token control function(s) defining one or more functions of the token, such as minting functions, burning functions, transfer functions, approve functions and/or balancing functions. The new token object may be generated based on existing token templates. The token templates may include templates corresponding to (1) fungible assets (i.e., assets that are not unique and mutually interchangeable) with variable supply, (2) fungible assets with fixed supply, (3) non-fungible assets (i.e., assets that are unique) with variable supply, and (4) non-fungible assets with fixed supply. The token templates may include control functions. Use of a token template to generate the transaction data may simplify the token creation process and ensures that the generated token(s) contain all required token control functions to allow desired handling of the token.

The transaction data may include a first address associated with the operating system 202, a second address associated with the operating system 202 and units of token(s) to be transferred. The transaction data may be provided to the distributed ledger network as previously described. Upon execution of the transaction, the quantity of the token specified in the transaction data is transferred from the first address to the second or further address. Hence, the balance of the first address decreased by the quantity specified in the transaction data while the balance of the second address increases by the same quantity. This allows to transfer previously minted units of a token to a further address.

The transaction data may be signed by a private key associated with the operating system 202. The generated transaction data may be provided to a node of the distributed ledger network 224 for deployment (e.g. creation) of the token (see for example FIG. 11A). The token may be created at the address specified in the transaction data. Hence, after successful deployment of the token, the balance of the address specified in the transaction data holds a token in a quantity specified in the transaction data. The generated transaction data may be provided to a node of the distributed ledger network for transfer to the specified units of the token to from the specified first address to the specified second address.

The distributed ledger network 224 may be a permissioned distributed ledger network. Hence, access to the distributed ledger network may be controlled by the organization operating the distributed ledger network. For instance, access to the distributed ledger network as well as access to data stored within the distributed ledger network may be based on access policies. This may avoid that transactions associated with token generation performed upon entry of the vegetable oil into chemical production network 206 are visible by each participant of the product ecosystem, hence avoiding that other participants of the product ecosystem gain insights on production processes performed within the chemical production network 206. The transaction data 222 may be generated based on the determined token units. The distributed ledger network 224 may be a blockchain as described in the context of FIG. 11A. The distributed ledger network 224 may process the received transaction data. Upon successful completion of the transaction associated with the transaction data 222, a token and associated token units 226 may be generated at an address associated with an account 228 of the distributed ledger network 224. Account 228 may be associated with operating system 202. The token units 226 may be linked to environmental attribute(s) associated with vegetable oil 208. Upon successful completion of the transaction associated with transaction data 222, token units may be transferred from a first an address of the distributed ledger network 224 to a second address associated with account 228 of the operating system 202.

The address associated with account 228 may be considered as a virtual balancing account or digital environmental attribute inventory. The address may hold credits in the form of token units linked to one or more environmental attributes. Since token(s) may be associated with metadata indicating the environmental attribute they are linked to, tokens may be differentiated from each other via their metadata. Hence, tokens associated with different environmental attributes may be assigned to one address, thus reducing the need of different addresses for tokens associated with different environmental attributes and hence reducing the complexity of the virtual balancing system. The address may be associated with the entity operating the chemical production network. The address may be associated with metadata identifying the environmental attributes linked to token(s) and associated units allocated to the address. The address may be associated with metadata identifying the production chain the address is associated with. The address may be associated with metadata identifying the input or chemical product the address is associated with. The metadata may be stored in a database associated with the operating system and may be used to determine a suitable address for allocating units of token(s) to a chemical product identifier. The address may be part of a virtual balancing system including multiple addresses. The address may hold units of token(s) for transaction. Units of token(s) and hence environmental attributes linked thereto may be transferred to (e.g. added) or from (e.g. deducted) the address. The address may be associated with an allocation scheme such as segregated allocation, non-segregated allocation like book and claim, mass balance with free attribution, mass balance without free attribution or combinations thereof.

Operating system 202 or attribute management system 220 may determine a value associated with the token units assigned to the address of account 228. For example, operating system 202 or attribute management system 220 may compute the difference in cost between sustainable vegetable oils 208 and corresponding equivalent conventional vegetable oils to determine the value of the token units. Operating system 202 may use average price, actual price, market price or other suitable values to determine the cost of the equivalent amount of fossil input materials. Operating system 202 may store and track the values corresponding to sustainable input materials in digital inventories (not shown). For example, the token units assigned to the address of account 228 may be associated with digital inventories which include the value information corresponding to vegetable oil(s) 208.

Operating system 202 may include a merger system 232 to create sustainable chemical products by combining token units with data stored in conventional product digital inventories. With reference to FIG. 4A to FIG. 4C, operating system 202 may processes an order for a product 234-242 received from a customer. If the customer purchased a conventional chemical product 234-240, operating system 202 may process the purchase using conventional product digital inventory 230.

If, however, the customer purchased a sustainable chemical product 242 (e.g. a chemical product associated with one or more environmental attribute(s)), operating system 202 may direct merger system 232 to combine token units assigned to an address of account 228 with conventional product data stored in digital inventory 230. Merger system 232 may generate one or more further token(s) (see FIG. 4A) that define (or specify) a sustainable chemical product from the combination of token units and conventional product data (e.g., using combining or bundling logic 404). Merger system 232 may create a sustainable chemical product as shown by FIG. 4A to FIG. 4C. Thus, operating system 202 enables chemical production network 206 to efficiently create multiple sustainable chemical products from input materials including sustainable vegetable oil(s) that are combined with conventional input materials in a large interconnected chemical production network.

FIG. 4A illustrates a merger system for producing sustainable chemical products involving the use of non-fungible tokens. The merger system 232 may be part of the operating system 202 described in the context of FIG. 2. Operating system 202 may receive order data associated with the order of a chemical product by a customer. The order data may include data being indicative of the chemical product to be purchased, such as a chemical product id and/or name and/or order number, and environmental attributes to be associated with the ordered chemical product. Operating system 202 may parse the order data to determine the data related to the chemical product and the target environmental attributes. Operating system 202 may generate a chemical product identifier associated with the ordered chemical product. Operating system 202 may provide the chemical product identifier and the target environment attributes to merger system 232.

Merger system 232 may select, based on the provided target environment attributes, at least one attribution rule for attributing units of token(s) linked to one or more environmental attributes to the chemical product. Merger system 232 may determine the units of token(s) based on the attribution rule(s). The units of token(s) may be determined by combining or bundling logic 404 of merger system 232.

Merger system 232 may generate, for the determined units of the token transaction data 408. The transaction data may include a new token object that defines the determined units of the respective token, the environmental attribute(s), such as certificate data associated with the sustainable origin of raw materials used to produce the chemical product, associated with the respective token, the provided chemical product identifier, an address associated with the operating system and token control function(s) defining one or more functions of the respective token, such as minting functions, burning functions, transfer functions, approve functions and/or balancing functions. The new token object may be generated based on existing token templates. The transaction data may be signed with a private key associated with operating system 202. The transaction data may be generated by a decentralized app running on merger system 232. With reference to FIG. 11A, merger system 232 may be a peer-to-peer module comprising an API configured to provide an interface to a peer-to-peer node of the decentralized ledger network 224. With reference to FIG. 11A, merger system 232 may be a peer-to-peer node comprising the peer-to-peer application described previously. Merger system 232 may provide the transaction data to decentralized ledger network 224. Decentralized ledger network 224 may be a peer-to-peer network as described in the context of FIG. 11A. Decentralized ledger network 224 may be a blockchain network. One or more nodes of the decentralized ledger network may validate the received transaction data and may append a new block to the existing blockchain including said transaction data. Validation may include checking the signature of the transaction data. Validation may result in creation of the one or more further tokens 418, such as non-fungible tokens, at the address specified in the transaction data (e.g. address 406).

The transaction data 408 may include the determined units of the token, the environmental attributes, such as certificate data associated with the sustainable origin of raw materials used to produce the chemical product, associated with the respective token, the provided chemical product identifier and an address associated with a third party. At least part of the transaction data, such as the determined units of the token and the address associated with the third party may be provided to the distributed ledger network 224 as previously described. Further parts of the transaction data may be provided to the third party generating the one or more token(s) on behalf of the entity operating the chemical production network 206. For example, the further parts may include the chemical product identifier. Based on the received units of token(s) as well as the further parts of the transaction data, the third party may create transaction data to generate the one or more further token(s) as described above. The created one or more further token(s) 418 may be assigned to an address of the third party and may be transferred from said address to address 406 or account 228 associated with operating system 202. The one or more further token(s) may be created directly at address 406 or account 228.

The one or more non-fungible token 418 may be uniquely associated with the chemical product via the chemical product identifier as illustrated in FIG. 4A. The one or more non-fungible token 418 may be provided as digital assets upon providing the physical chemical product 242 to the chemical product consumer having ordered said chemical product. Providing the non-fungible token 418 may include transferring the non-fungible token from address 406 or account 228 associated with operating system 202 to an address associated with the chemical product consumer via a transaction recorded within the decentralized ledger network 224 (see also FIG. 11C).

FIG. 4B illustrates a merger system for producing sustainable chemical products involving the use of addresses associated with chemical product identifiers. In contrast to the example of FIG. 4A, merger system 232 may transfer the determined units of the token to an address 412 associated with the chemical product identifier 414. The address may be associated with account 228. For instance, a plurality of addresses 416 may be generated based on the seed phrase associated with account 228. Each generated address may be associated with a chemical product identifier. The linking between generated address 412 and chemical product identifier may be stored in a database of merger system 232 (not shown). Upon receiving the chemical product identifier, merger system 232 may gather the respective address from said database and may generate transaction data to transfer the units of the token from the address associated with account 228 to address 412. The transaction data may include the units of the token and address 412. The transaction data may be provided to the distributed ledger network 224 for execution of the transaction. The transaction data may be generated by a decentralized app running on merger system 232 as described in the context of FIG. 4A.

The distributed ledger network 224 may be a permissioned distributed ledger network as described in the context of FIG. 2. This allows to ensure the required level of privacy and security concerning the generation of token(s) linked to environmental attributes associated with vegetable oils since such token generation provides insights into production processes performed within the chemical production network which are desired to be kept confidential by the entity operating such chemical production network.

Upon providing the physical chemical product 242 to the customer, the units of the token assigned to address 412 may be transferred to an address of the distributed ledger 224 associated with the customer of chemical product 242.

FIG. 4C illustrates a merger system for producing sustainable chemical products involving the use of a vault address to lock and unlock units of tokens linked to environmental attributes, such as certificate data associated with the sustainable origin of raw materials used to produce the chemical product. In contrast to the example illustrated in FIG. 4A and FIG. 4B, merger system 232 may lock determined units of a token at a vault address 422. The vault address may comprise an executable means which may be invoked by a transaction to the (unique) communication address of the executable means, e.g. to the vault address 422. The executable means may allow to lock units of the token using a secret. The secret may, for example, include a hash of the chemical product identifier.

For locking of the determined units of the token, merger system 232 may generate transaction data 420. The transaction data may be generated by a decentralized app running on merger system 232 as described in the context of FIG. 4A. The transaction data may include the determined units of the token, the secret and the vault address. The transaction data may be provided to the distributed ledger network 224 as described previously. Upon execution of the transaction associated with the transaction data, the units of token will be deducted from the address associated with account 228 and will be locked at the vault address 422.

The secret as well as the vault address to unlock the units of tokens may be provided to the customer, for example using a product passport as described in the context of FIG. 8A and FIG. 8B. Using the secret, the customer may generate transaction data to unlock the units of tokens locked at the vault address 422. Hence, the digital asset associated with the physical chemical product 242 may be provided via the secret and the vault address to the customer of the chemical product.

The distributed ledger network 224 may be a permissioned distributed ledger network as described in the context of FIG. 2. This allows to ensure the required level of privacy and security concerning the generation of token(s) linked to environmental attributes associated with vegetable oils since such token generation provides insights into production processes performed within the chemical production network which are desired to be kept confidential by the entity operating such chemical production network.

The principles illustrated in FIG. 4A to FIG. 4C ensure that units of tokens representing environmental attributes, such as certificate data associated with the sustainable origin of raw materials used to produce the chemical product, which are allocated to chemical products are deducted from the available units of tokens generated from environmental attributes associated with input materials. Hence, it may be ensured that the order of the customer regarding a chemical product and its environmental attributes may be fulfilled. Additionally, the remaining environmental attributes are made transparent via the balance of token units allocated to the address of account 228. The token units remaining in the address of account 228 may either be used to produce further chemical products associated with environmental attributes of the vegetable oil. The remaining token units may be provided to a third party requiring environmental attributes for chemical products produced from such vegetable oils. Hence, the token units may be traded as a digital currency and may allow to flexibly produce chemical products associated with environmental attributes according to the customers' needs by several chemical productions without the need to source input materials associated with the environmental attributes required by the customer. This avoids supply shortages due to limited availability of vegetable oils associated with the required environmental attributes.

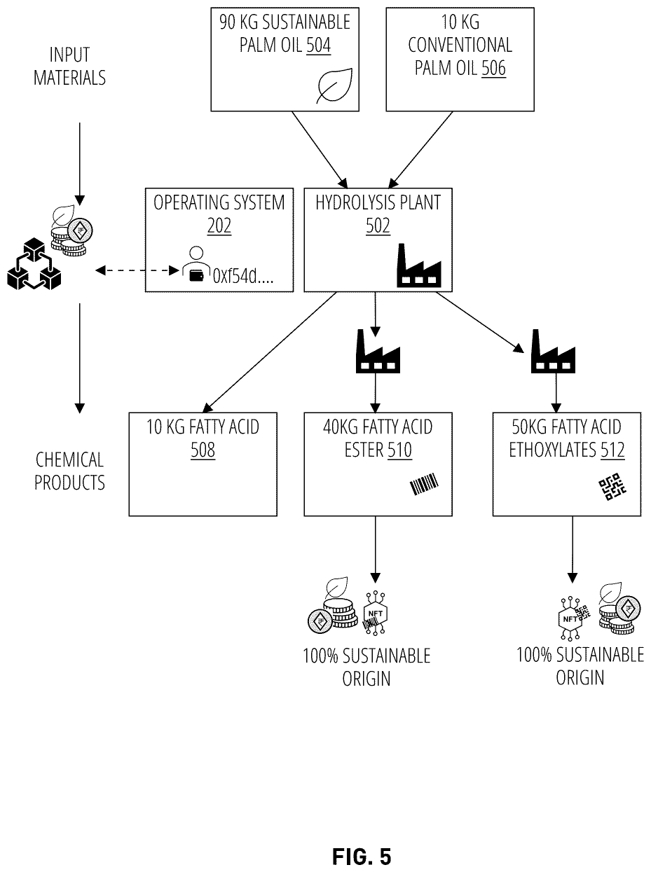

FIG. 5 illustrates an example of the converting environmental attributes associated with vegetable oil(s) to token units and assignment of such token units to different chemical products produced using such vegetable oil(s). Based on the non-limiting example of FIG. 5 sustainable origin feedstock may be provided to hydrolysis plant 502 of chemical production network 206. For illustrative purposes the following input materials may be provided to the hydrolysis plant 502 in the following amounts:
90 kg sustainable origin input material, such as sustainable palm oil,
10 kg non-sustainable origin input material, such as non-sustainable palm oil.

On providing these input materials to the hydrolysis plant 502, the input materials enter the chemical production network. The environmental attributes of the sustainable origin input materials may be determined as described in the context of FIG. 2. Based on the determined environmental attributes, units of token(s) linked to such environmental attributes may be determined and transaction data may be generated for such determined units of token(s) as described in the context of FIG. 2. Upon execution of the transaction associated with such transaction data by a distributed ledger network, units of tokens may be created at or may be assigned to an address associated with the operating system 202 of the chemical production network 206. The units of tokens may be determined based on the amount of respective vegetable oil. In the example, the environmental attribute sustainable origin from sustainable palm oil may correspond to 90 units of a sustainable origin token. In this example, a simplified weight-based approach is used for illustrative purposes only. Other approaches may be based on energy, atom counting such as carbon atoms, molecule counting, or include losses that occur in production.

The hydrolysis plant 502 may produce fatty acids, which may be further processed and chemically converted. In the illustrative example, 10 kg fatty acid as hydrolysis plant 502 product, 40 kg fatty acid ester 510 and 50 kg fatty acid ethoxylates 512 may be provided to the exit point of the chemical production network 206. Since for the production of such products 90 kg sustainable origin input materials were used, token units associated with such sustainable input materials and stored in the address associated with operating system 202 may be assigned to such chemical products. For instance, 40 units of the sustainable origin token may be assigned to fatty alcohol ethoxylate, which corresponds to 100% sustainable origin content, and 50 token units of the sustainable origin token may be assigned to fatty acid ethoxylates, which likewise corresponds to 100% sustainable origin content. In another instance, only part of the 90 token units associated with the 90 kg of sustainable input material may be assigned to the fatty alcohol ethoxylate and/or the fatty acid ethoxylate, resulting in unused token units available at the address. Such unused token units may be assigned to further chemical products produced by chemical production network 206 or may be transferred to environmental attributes platform 114 as described in the context of FIG. 1.

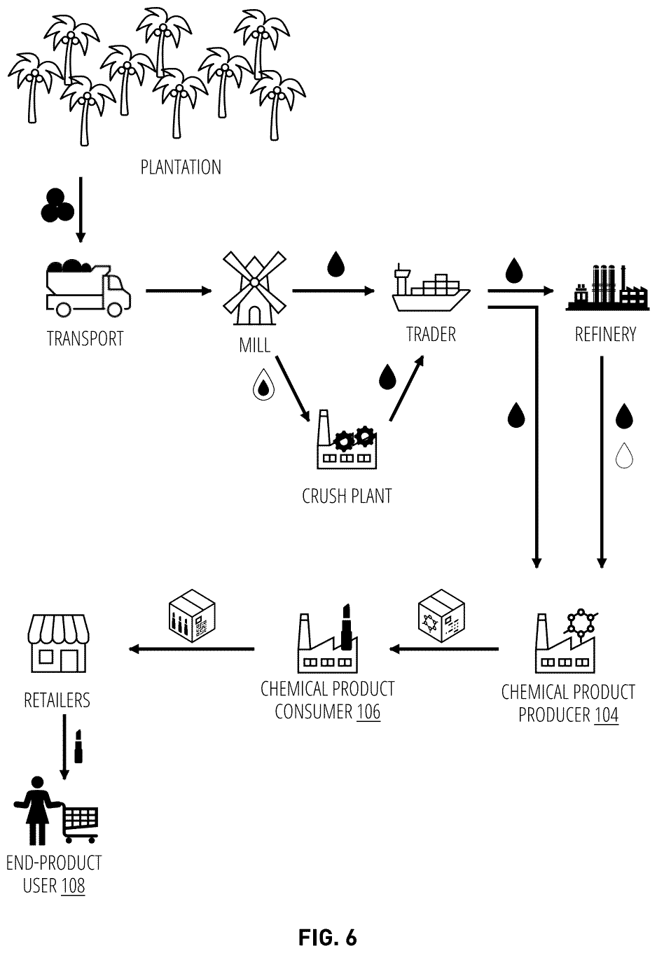

FIG. 6 illustrates a schematic drawing of an exemplary supply chain of palm oil and palm kernel oil up to the manufacturing of end products provided via retailer(s) to end-product users 108. Any other vegetable oil production, such as coconut oil production, olive oil production, rapeseed oil production, etc., is equivalently usable and the mere explanation by the palm oil and palm kernel oil example shall not limit the scope of the underlying concepts lined out here.

Palm oil may be extracted from the flesh of the Palm fruit. Palm Kernel Oil may be extracted from the seeds or kernels of the Palm fruit. Fresh fruit bunches (FFB) of oil palm may be harvested by palm oil companies from plantations or may be supplied to said companies from third party suppliers. The harvested FFB may then be transported to mills to extract Crude Palm Oil (CPO). The Crude Palm Oil may be extracted from the fresh Palm fruit flesh by pressing and centrifugation. The Crude Palm Oil extraction may be done with the fresh Palm fruit to avoid the deterioration of Palm Oil. The palm kernels resulting from the milling process may be transported to crushing companies. Said companies may crush the palm kernels and extract palm kernel oil. Said crude palm kernel oil may then be transported to traders.

The oil extracted from the fruits and/or kernels, such as CPO and crude palm kernel oil, may be traded by traders. Said traders may buy oil extracted by mills and/or crushers and may sell said oil to refineries or chemical product producer 104. The chemical product producer 104 may operate a chemical production network, such as chemical production network 206 described in the context of FIG. 2. The chemical product producer 104 may produce chemical product(s) using the oil provided by traders, for example as described in the context of FIG. 1. The received oil may be associated with vegetable oil data, such as described in the context of FIG. 2. The vegetable oil data may include certificate data. The certificate data may indicate that the production of the oil (e.g. plantation, transport, milling, crushing, refining) has been performed according to predefined production criteria as described in the context of FIG. 1. Certificate data may be generated by independent authorities which ensure that the criteria for certification are fulfilled and may be provided to producers of the palm oil and palm kernel oil. For example, the oil data may include RSPO (round table on sustainable palm oil) certificate data. The vegetable oil data may be gathered by chemical product producer 104, for example as described in the context of FIG. 8A and FIG. 8B.

The refinery may refine the vegetable oil, such as CPO and crude palm kernel oil, by various processes to remove unwanted impurities which may adversely affect the physical appearance, quality, oxidative stability and/or shelf life of the vegetable oil. Refining may include the steps of bleaching, deodorizing/de-acidification and fractionating to obtain oil fractions, such as palm olein and stearin. The refined products may then be transported to chemical product producer 104 as previously described.

The chemical products produced by chemical product producer 104 may be supplied to chemical product consumer 106. Chemical product consumer 106 may produce further products, such as further chemical products or discrete products, at least in part from the chemical products received from chemical product producer 104 as described in the context of FIG. 1. Environmental attributes associated with the provided chemical products may be provided by chemical product producer 104 as described in the context of FIG. 1.

Chemical product consumer 106 may produce end-products from chemical products received from chemical product producer 104. The end-products may include cosmetic products, such as lipsticks, shower gels, shampoos, etc. Such cosmetic products may include one or more chemical products received from chemical product producer 104. Such end-products may be associated with environmental attributes (see FIG. 1). Such environmental attributes may be provided to end-product user 108 as described in the context of FIG. 1.

The end-products produced from palm oil and palm kernel oil as raw material, may be supplied to retailer(s) which may sell them to end-product user 108.

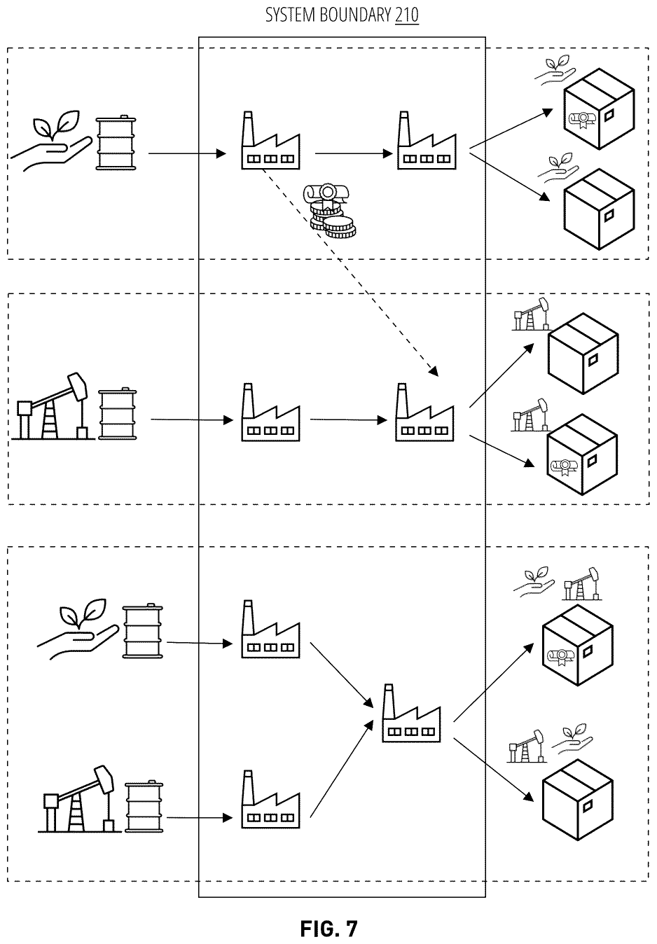

FIG. 7 illustrates an example of a chemical production network associated with different allocation schemes. The allocation schemes may be used to allocate the use of vegetable oils associated with environmental attributes (such as sustainable origin) to chemical products produced by the chemical production network.

The chemical production network may include multiple production chains with different allocation schemes. The system boundary of the chemical production network may be defined by the entry points to the chemical production network and the exit points from the chemical production network. The production chains may be defined by the chemical product(s) produced via such production chains. The production chain logic may be based on process data associated with process steps from input material(s) to chemical product(s). For each production chain an allocation scheme may be applicable (and the application allocation scheme may be assigned to the production chain). In addition for each production chain a balancing system (e.g., an address associated with the distributed ledger network) may be applicable or the production chain logic may be embedded in the attribution rules.

Accounting principles for allocating the use of sustainable origin content are for example defined in ISO 22095. Four different chain of custody models may be used: Identity preservation models, segregated models, mass balance models, or book and claim models.

In segregated models, the production chains for producing chemical product(s) from conventional vegetable oil(s) and the production chains for producing chemical product(s) from vegetable oils(s) having a sustainable origin are separated, e.g. are not interconnected. The first and the second production chains produce conventional-based and sustainable origin-based chemical product(s), respectively.

In the mass balancing model, the physical mixing or co-feeding of vegetable oil having a sustainable origin with conventional vegetable oil is accounted for. Here the feed into the production network and the feed of output products form a system boundary. The mass balance of vegetable oil(s) and chemical products connects the used vegetable oil having a sustainable origin to the produced output product. Mass balance allows to keep track of the total amount of vegetable oil (e.g. vegetable oil having a sustainable origin) throughout the production network and allows for allocation to chemical products. Materials with different sets of specified characteristics may be mixed. E.g. feedstock having a sustainable origin replaces an equivalent amount of conventional feedstock at the beginning of the value chain (input material) and is allocated to a product (chemical product) in such a manner that the input and output match. For this model, the proportion of the input with specified characteristics might only match the initial proportions on average and will typically vary across different outputs. This means that e.g., vegetable oils having a sustainable origin and conventional vegetable oils are mixed and that the chemical or technical proportions in each chemical product are not tracked.

Mass balance may include conversion factors to ensure the amount of vegetable oil is correlated with the amount of chemical product. The calculation may be made over a pre-defined or specified time period. Mass balance may be based on a balancing unit such as mass, energy, or carbon.

In a book and claim scheme, the characteristic vegetable oil having a sustainable origin is not linked to the actual material flows. Book & Claim allows to de-couple a specific characteristic, such as sustainable origin, from the physical product and to transfer the characteristic separately via a dedicated registry in the form of a digital asset. Book and claim may be based on a book and claim accounting unit such as volume or mass for vegetable oil having a sustainable origin. Such a scheme may be used if units of token(s) are acquired from environmental attributes platform 114 as described in the context of FIG. 1. FIG. 8A illustrates an example embodiment of a decentral network environment. The decentral network environment may include a decentral participant network 822. The decentral participant network 822 may include one or more decentral network participants 104, 106, 802, 804 and 806. The decentral network participants may be part of a product ecosystem including chemical products. The product ecosystem may include production chains to produce an end-product. The product ecosystem may include recycling chains to recycle at least part of an end-of-life product. The product ecosystem may include a vegetable oil supplier 802, a chemical product producer 104, a chemical product consumer 106, an end-product user 108, an EOL product collector 804 a recycler 806 and a vegetable oil supplier 802. The decentral participant network 822 may represent a product ecosystem. The product ecosystem may allow to use materials resulting from recycling of end-of-life products to produce new products, such as chemical products. The product ecosystem may be associated with the production and/or recycling of physical products. The product may be a chemical product, an intermediate chemical product, a component, a component assembly, an end product, an end-of-life product or a recycled product.

The participant(s) of the decentral participant network 822 may be associated with the production the product and/or recycling of the product. The decentral network participant 104, 106, 802, 804 and 806 may refer to a manufacturer of physical products, such as vegetable oil supplier 802, chemical product producer 104, chemical product consumer 106, end-product user 108, a user of physical goods, such as EOL product collector 804, and/or a participant of a recycling chain associated with the physical product, such as recycler 806. The decentral network participant may be associated with a decentral participant identifier. The decentral participant identifier may uniquely identify the decentral network participant within the decentral participant network 822.

The participant(s) of the decentral participant network 822 may be connected via material flow 824. The material flow 824 may correspond to the flow of product from one participant of the decentral participant network 822 to the downstream participant of the decentral participant network 822. The material flow 824 may refer to a continuous or a discontinuous flow of product. The flow of product may include any means of transportation suitable to transport the product from a participant to the downstream participant. The means of transportation may include pipes, containers, barrels, packages. The material flow 824 may be associated with raw materials used to produce the chemical product, such as vegetable oils. The raw materials may be provided to the chemical product producer 104 for producing chemical product(s) and/or intermediate chemical product(s).

At least part of the participants of the decentral participant network 822 may be associated with decentral participant network nodes 810 to 820. The decentral participant nodes 810 to 820 may be under control of the respective decentral participant associated with the respective decentral participant node. The decentral participant nodes 810 to 820 may form decentral network 828. The decentral network 828 may be a peer-to-peer communication network. The decentral network 828 may be configured to perform data transactions 826. The data transactions 826 may be based on a transaction protocol including authentication and/or authorization mechanism(s). Based on the authentication and/or authorization mechanism(s) a peer-to-peer communication between decentral network nodes 810 to 820 associated with decentral network participants 104, 106, 802, 804 and 806 may be established. The one or more authentication mechanism(s) may be associated with or linked to a decentral identifier as described in the context of FIG. 8B. The one or more authentication mechanism(s) associated with the decentral identifier may be accessible by a decentral data providing network node and/or a decentral data consuming network node as described in the context of FIG. 8B. The decentral configuration allows for more efficient use of computing resources and strengthens control by the data owners of the decentral network.

Data transactions between decentral network participant nodes may be based on a decentral identifier associated with respective product data to be accessed, for example as described in the context of FIG. 8B. The decentral identifier may be uniquely associated with the physical entity of the product and associated product data. The decentral identifier may uniquely identify the respective product within the decentral network. The decentral identifier may be associated with further decentral identifier(s), such as decentral identifier(s) of product(s) used to produce the product. This may allow to track the product(s) used to produce a product, such as an end-product. The decentral identifier may be included in a digital access element associated with the product, for example as described in the context of FIG. 8B.

The data flow 826 (e.g. transactions) between decentral network participant nodes may be directly or indirectly associated with the material flow 824 between the decentral network participants. For instance, data flow 826 may be directly associated with material flow 824 if data associated with a vegetable oil provided from the vegetable oil supplier 802 to the chemical product producer 104 is accessed by a decentral data consuming network node (such as node 812) associated with said chemical product producer 104. For instance, data flow 826 may be indirectly associated with material flow 824 if data associated with a chemical product produced by chemical product producer 104 is accessed by a decentral data consuming network node associated with recycler 806 (such as node 820).

The decentral participant nodes 810 to 820 may be decentral computing nodes. The decentral computing node may be any device or system that includes at least one physical and tangible processor, and a physical and tangible memory capable of having thereon computer-executable instructions that are executed by a processor. The memory may take any form and depends on the nature and form of the computing node.

At least part of the decentral participant nodes 810 to 820 may be decentral data providing network nodes. At least part of the participant nodes 810 to 820 may be decentral data consuming network nodes. A participant of the decentral participant network 822 may be associated with a decentral data providing network node and/or a decentral data consuming network node depending on whether data is provided to downstream participants and/or consumed from upstream participants. For instance, vegetable oil supplier 802 may be associated with a decentral data providing network node configured to provide vegetable oil data to a downstream participant (e.g. chemical product producer 104) for example as described in the context of FIG. 8B. In addition to or alternatively, chemical product producer 104 may be associated with a decentral data consuming network node configured to access data associated with a recycled input material produced by an upstream participant (e.g. vegetable oil supplier 802).

The decentral network 828 may include further decentral network nodes. The further decentral network nodes may be decentral infrastructure service nodes (not shown in FIG. 8A). The decentral infrastructure service nodes may not be associated with a participant of the product ecosystem. The decentral infrastructure service nodes may provide services for decentral participant nodes 810 to 820, such as verifying the identity of the decentral network participant nodes 810 to 820 prior to performing a data exchange. The decentral network participant nodes 810 to 820 may be associated with or include certificate(s), such as X.509 certificate(s). The certificate(s) may be associated with decentral infrastructure service node(s) including e.g. a certificate issuing service and/or a dynamic provisioning service providing dynamic attribute tokens (e.g. OAuth Access Tokens). This way the decentral network participant nodes 116 to 124 possess a unique identifier embedded in a X.509 certificate that identifies the respective decentral network participant node 810 to 820. The information required to verify the certificate may be provided via an authentication registry associated with the certificate issuing service and/or a dynamic provisioning service. For instance, in the IDSA Reference Architecture Model, Version 3.0 of April 2019, a decentral data providing network node associated with a data owner, a Certification Authority (CA), a Dynamic Attribute Provisioning Service (DAPS) and a decentral data consuming network node associated with a data consumer are used to verify the identity prior to performing a data exchange (not shown).

FIG. 8B illustrates an exchange of input material data associated with input material provided to a chemical production network via a decentral peer-to-peer network. Access to the input material data twin data may be requested by a decentral data consuming service associated with a participant of the decentral network 822 (see FIG. 8A). The participant may be a chemical product producer 104 receiving input materials from a vegetable oil supplier 802 and/or a recycler 806 (see FIG. 8A). The input material 204 may be associated with a digital twin including input material data. The digital twin may include a decentral identifier and input material data. The input material data may comprise one or more environmental attributes associated with the input material. For instance, input material, such as pyrolysis oil, received from recycler 806 may be associated with the environmental attribute “recycled” and waste type “tires”. The environmental attribute “recycled” and the waste type “tires” may be contained within the input material data. For example, input material such as vegetable oil, received from vegetable oil supplier 802 may be associated with the environmental attribute “sustainable origin” and the vegetable oil type “palm oil”. The input material may be associated with a digital access element generated upon or after production of the input material. The digital access element may be associated with the digital twin or the part thereof. The digital access element may contain a decentral passport identifier and digital twin location data. The decentral passport identifier may correspond to or be associated with the decentral identifier of the digital twin. The digital twin location data may include digital representation(s) pointing to the digital twin or parts thereof. The digital access element may further include or relate to authentication and/or authorization information linked to the decentral passport identifier. The authentication and/or authorization information may be provided for authentication and/or authorization of the decentral data providing network node 812 and/or the decentral data consuming network node 812. The digital access element may be provided to a decentral registry 842. Decentral registry 842 may store decentral passport identifier(s) and associated digital twin location data.

The input material 208 as produced by vegetable oil supplier 802 and/or recycler 806 may be provided in association with the digital access element to chemical product producer 104. The chemical product producer 104 may process the input material to produce further chemical products, for example as described in the context of FIG. 1 and FIG. 2. The input material 208 may be connected to a code, such as a bar code or QR-code, having encoded the decentral passport identifier. The chemical product producer 104 may read the code through a code reader 830. The code reader 830 may be a smartphone running a code reading application, such as a QR code reader app. The data obtained by the code reading application may be used to determine the decentral passport identifier. The data obtained by the code reading application may be used to determine the decentral identifier. The data obtained by the code reading application may be used to determine the input material identifier. The data obtained by the code reading application may be used to determine the digital twin location data. The decentral passport identifier, decentral identifier, input material identifier and digital twin location data may be determined by code reader 830. For instance, the decentral passport identifier determined by the code reader 830 may be a DID and the code reader 830 may be configured to retrieve the associated DID document containing the decentral digital twin identifier and the digital twin location data, for example using a DID resolver. In another instance, the input material identifier is determined by code reader 830 and used to retrieve the decentral passport identifier and associated digital twin location data, for example from a database, decentral registry 842. Hence, code reader 830 may be configured to retrieve the digital access element containing the decentral passport identifier and digital twin location data from decentral registry 842. Code reader 830 may be configured to provide the decentral passport identifier and/or the decentral identifier to a database, such as database 848, associated with chemical product producer 104. Code reader 830 may be configured to provide the determined decentral passport identifier, decentral identifier and digital twin location data to decentral data consuming network node 812.

Code reader 830 may be configured to display determined/retrieved data on a user interface as illustrated by reference sign 832. The user interface may display the determined decentral passport identifier (PP identifier), the determined decentral identifier (DT identifier) and the determined digital twin location data (DT location). In this embodiment, the decentral passport identifier and the decentral identifier differ from each other. In another embodiment, the decentral passport identifier is equal to the decentral identifier. The user interface may further display the determined input material identifier (IP identifier). The user interface may also allow to initiate retrieval of the digital twin or a part thereof based on the decentral passport identifier and the digital twin location data as described in the following. This process may be initiated by the button denoted “Access DT”. Upon pressing said button, code reader 830 may send a request to access the digital twin or the part thereof to decentral data consuming network node 812.

Decentral data consuming network node 812 may generate a request to access the digital twin data. Decentral data consuming network node 812 node may generate the request based on the data received from code reader 830. For instance, decentral data consuming network node 812 may generate the request based on the decentral digital twin identifier received from code reader 830. Decentral data consuming network node 812 may generate the request based on the decentral passport identifier and/or decentral identifier provided to database 218. For example, decentral data consuming network node 812 may be configured to retrieve the decentral identifier and digital twin location data from decentral registry 842 based on the decentral passport identifier stored in database 848. The request generated by decentral data consuming network node 812 may include the decentral identifier and the decentral participant identifier of the chemical product producer 104 associated with decentral data consuming network node 812. The request may include one or more actions to be performed on the digital twin data. Decentral data consuming network node 812 may be configured to determine the decentral data providing network node 812 associated with the digital twin based on the digital twin location data provided by code reader 830 or retrieved from decentral registry 842.

Decentral data consuming network node 812 may sent the request to access the digital twin data to the determined decentral data providing network node 812 as signified by arrow 834. The decentral data providing network node 812 may be associated with the vegetable oil supplier 802. The decentral data providing network node 812 may be associated with vegetable oil supplier 802. The decentral data providing network node 812 may be associated with the chemical production producing the input material. The decentral data providing network node 812 may be associated with the data owner of the digital twin. In addition to the request, authentication and/or authorization information may be provided by decentral data consuming network node 812.

The request may be authenticated. Access to the input material data may be authorized based on access policy data associated with the input material data. This allows to filter decentral data consuming network nodes requesting access based on the decentral participant identifier(s) associated with said network nodes and requested actions to be performed on the accessed data. If the request is not authorized, e.g. if decentral data consuming network node 812 is not authorized to access the digital twin data, the peer-to-peer communication channel will be terminated by decentral data providing network node 812 and no input material data will be provided.

If the request is authorized, decentral data providing network node 812 may initiate contract negotiations with decentral data consuming network node 812 prior to providing input material data. Decentral data providing network node 812 may provide an electronic contract to decentral data consuming network node 812. The electronic contract may include one or more authorization rule(s) associated with the decentral identifier. This allows the data consumer to determine access and usage conditions associated with the desired data. Decentral data providing network node 812 and decentral data consuming network node 812 may be configured to negotiate an electronic contract and to sign the negotiated electronic contract. Use of the electronic contract ensures that the decentral data consuming network node and further systems handling the digital twin are complying to one or more authorization rule(s) associated with the digital twin. Upon signature of the electronic contract, input material data may be gathered and access rights may be applied to the gathered data as signified by arrows 836 and 838. The input material data resulting from applying access rights to gathered input material data may be provided by decentral data providing network node 812 to decentral data consuming network node 812 as signified by arrow 840.

The input material data provided by decentral data providing network node 812 may be stored in database 218 associated with the decentral data consuming network node 812 according to the access data as signified by arrow 846.

Through the decentral identifier, input material data can be uniquely associated with the input material. Through the decentral network, the digital twin or a part thereof may be transferred between vegetable oil supplier 802 and/or recycler 806 and chemical product producer 104 in a standardized and secure way, allowing vegetable oil supplier 802 and/or recycler 806 to control access to the input material data by multiple decentral data consuming network nodes existing within the decentral network. This way, the input material data including environmental attributes can be shared with unique association to the input material and without central intermediary directly between the participants of the product ecosystem 822. This allows for transparency of digital twins and standardized and secure sharing of environmental attributes within the product ecosystem 822.

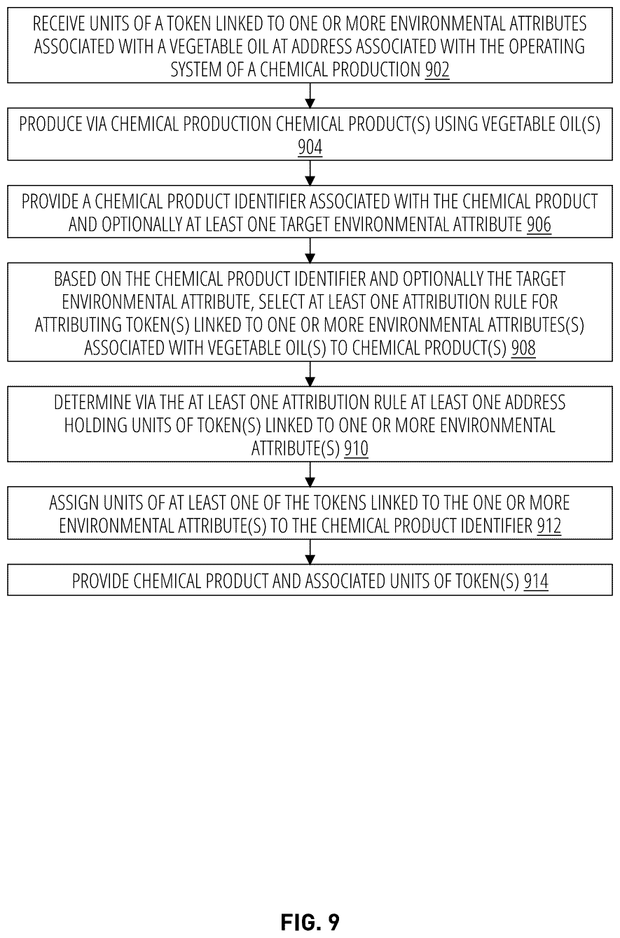

FIG. 9 illustrates an example of a method for producing a chemical product associated with at least one environmental attribute. The chemical product may be produced by a chemical production associated with chemical product producer 2 112. The chemical production may be a chemical production network, such as described in the context of FIG. 2. The method may be performed by the operating system associated with the chemical production. The chemical production may be different from the chemical production network creating units of tokens upon entry of vegetable oil(s) associated with environmental attributes to said chemical production network.

The environmental attribute(s) may be associated with production data of the vegetable oil, for example as described in the context of FIG. 1. The environmental attribute may be associated with or correspond to certificate data being indicative of a production of the vegetable oil according to predefined production criteria, for example as described in the context of FIG. 1.

In block 902, units of a token linked to one or more environmental attributes associated with a vegetable oil may be received at address associated with the operating system of the chemical production. The units of a token may be received from environmental attributes platform 114 as described in the context of FIG. 1 and FIG. 11B. The received units of the token may be created by an operating system of a chemical production network upon entry of vegetable oil(s) associated with environmental attributes as described in the context of FIG. 2. The received units of the token may correspond to units not having been assigned to chemical products and having been transferred to environmental attributes platform 114, for example as described in the context of FIG. 1.

In block 904, the chemical product may be produced by the chemical production using one or more vegetable oil(s). The vegetable oil(s) may not be associated with environmental attributes. Producing the chemical product from vegetable oil(s) may include the use of vegetable oil(s) in at least one production step associated with the production of the chemical product. Hence, the vegetable oil(s) may be used to produce intermediate chemical products which may then be used to produce the chemical product. The chemical product may be a chemical product as described in the context of FIG. 1.

In block 906, a chemical product identifier associated with the chemical product and optionally at least one target environmental attribute may be provided. The chemical product identifier may be provided based on order data associated with an order of the chemical product received from a customer. The order data may include data being indicative of the chemical product. Such data being indicative of the chemical product may include a chemical product ID, a chemical product name, an order number or a combination thereof. The order data may further include the target environmental attribute desired by the customer. The order data may be received by operating system 202. Operating system 202 may parse the order data to determine the data being indicative of the chemical product and/or the target environmental attribute. Based on the result of the data parsing, operating system 202 may determine the chemical product identifier. The chemical product identifier may be associated with an environmental attribute. Based on the parsed data, the operating system 202 may provide an environmental attribute identifier associated with the target environmental attribute. The environmental attribute identifier and/or the chemical product identifier may be associated with a defined units of the token. The chemical product identifier may relate to a chemical product class and/or a specific chemical product. The chemical product identifier may include a unique number uniquely associated with the chemical product class and/or the specific chemical product. The chemical product identifier may include one or more specific identifier(s), such as chemical product class identifier and/or specific chemical product identifier. Such specific chemical product identifier(s) may be uniquely linked to the chemical product. For example, one or more property identifier(s) may be uniquely linked to the chemical product identifier. The chemical product identifier may be uniquely linked to the specific chemical product. This way the chemical product can be uniquely linked to a digital twin of the chemical product specifying specific properties of the chemical product.

In block 908, at least one attribution rule for attributing token(s) linked to one or more environmental attributes(s) associated with vegetable oil(s) to chemical product(s) may be selected based on the chemical product identifier and optionally the target environmental attribute. The attribution rule may map the environmental attribute type such as sustainable origin vegetable oil to chemical product identifier(s). The attribution rule may map the environmental attribute type such as sustainable origin vegetable oil and the input material type such as sustainable palm oil, palm kernel oil, coconut oil to a chemical product identifier(s). The attribution rule may map the environmental attribute type such as sustainable origin vegetable oil and production chain such as the esterification production chain to chemical product identifier(s). The attribution rule may map the environmental attribute type such as sustainable origin vegetable oil and the attribution scheme such as mass balance with and without free attribution to chemical product identifier(s). The attribution rule may map the environmental attribute type such as sustainable origin vegetable oil and the chemical product type such as fatty acid ester to chemical product identifier(s).

The at least one attribute rule may include instructions configured to select units of token(s). Depending on the chemical product and the vegetable oils such chemical product is produced from different token(s) may be accessible for the chemical product. The vegetable oils may be determined from a bill of materials including the recipe for the production chain up to the chemical product. The production chain may include the input materials that enter the system boundary of the chemical production at any stage. From the vegetable oils used to produce the chemical product the accessible tokens associated with such vegetable oil types may be determined. For each accessible token, accessible token units may be determined from the address balance and the vegetable oil type used to produce chemical product. Such determination may result in one or more tokens being accessible for the chemical product and the target environmental attribute. For example, the target environmental attribute may refer to sustainable origin irrespective of the vegetable oil type. The token(s) for different vegetable oils may hence be accessible. Depending on the respective address balance one or more combinations of token(s) may be accessible. One combination of accessible tokens may be selected for example based on the combination with the highest address balance. This way the environmental attributes required by other stricter target environmental attributes may still be fulfillable.

In block 910, at least one address holding units of token(s) linked to one or more environmental attribute(s) may be determined via the at least one selected attribution rule. The address may be associated with the operating system 202. The token(s) assigned to said address may be tokens received in block 902. This block may further include determining the units of token(s) to be assigned to the chemical product identifier. The units of token may be determined based on the selected attribution rule. The units of token(s) may be determined based on the amount of chemical product and the chemical product identifier. The units of token(s) may be determined based on the amount of chemical product and the environmental attribute identifier.

In block 912, units of at least one of the tokens linked to the one or more environmental attribute(s) may be assigned to the chemical product identifier. Assignment may be performed as described, for example, in the context of FIG. 4A to FIG. 4C. Assignment may include
checking the balance of addresses holding token(s) associated with the determined token units and assigning the determined units of token(s) from the associated address to the chemical product identifier if the balance is sufficient, and/or
checking that the respective token(s) are associated with input material(s) used to produce the chemical product and assigning the determined units of token(s) from addresses holding said units to the chemical product identifier if the respective token(s) is/are associated with input material(s) used in the production chain of the chemical product.

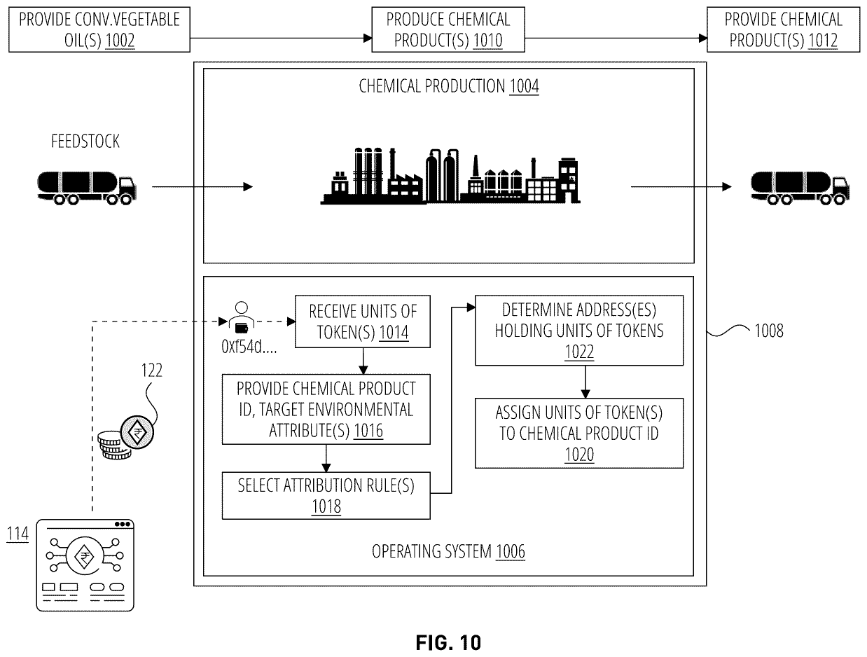

FIG. 10 illustrates an example of a system for producing at least one chemical product associated with one or more environmental attribute(s) including an example method for assigning at least one environmental attribute to the at least one produced chemical product.

The system may include a chemical production 1004 configured to produce the at least one chemical product using one or more vegetable oil(s). Chemical production 1004 may correspond to chemical production network 206 described in the context of FIG. 2. The vegetable oil(s) may be provided as feedstock to the chemical production 1004. The vegetable oil(s) may be conventional vegetable oil(s), e.g. vegetable oil(s) not being associated with environmental attributes. The vegetable oil(s) may be associated with unsuitable environmental attributes, e.g. environmental attributes not desired by the entity operating chemical production 1004 and/or customers of such an entity. The produced chemical products may be provided at exit points of the chemical production network 206. The produced chemical products may be provided to chemical product consumer 106 (see for example FIG. 6, FIG. 8A and FIG. 8B).

On the virtual layer, operating system 1006 of chemical production 1004 may perform blocks 1014 to 1020. Blocks 1014 to 1020 may correspond to the method illustrated in FIG. 9. Hence, operating system 1006 may perform-on the virtual layer-the method illustrated in FIG. 9. Operating system 1006 may be connected to a peer-to-peer network, such as distributed ledger network 224, associated with environmental attributes platform 114 (not shown). Environmental attributes platform 114 may be a decentralized app running on a node of the distributed ledger network 224. The distributed ledger network may be a distributed ledger network as described in the context of FIG. 11A. The operating system may be associated with a peer-to-peer module configured to provide an API to the peer-to-peer network, for example as described in the context of FIG. 11A. Operating system 202 may be configured to request units of token(s) from environmental attributes platform 114, for example as described in the context of FIG. 11B.

The system illustrated in FIG. 10 may hence include a physical layer where chemical products are produced from one or more vegetable oil(s) and provided to exit points of the chemical production and a virtual layer where environmental attribute(s) associated with such vegetable oil(s) are assigned to chemical products produced therefrom.

FIG. 11A illustrates an example of a participant network of a product ecosystem associated with a decentral peer-to-peer network for exchange of environmental attributes associated with vegetable oil(s) used as input materials to produce chemical product(s). The participant network may be a decentral participant network 1130. The decentral participant network 1130 may include one or more decentral network participants 104, 106, 108, 112, 114, 1102, 1106 and 1108. The decentral network participants may be part of a product ecosystem including chemical products as described in the context of FIG. 8A.

The participant(s) of the decentral participant network 1130 may be associated with the production the product and/or recycling of the product. The decentral network participant 104, 106, 108, 112, 114, 1102, 1106 and 1108 may refer to a manufacturer of physical products, a user of physical goods and/or a participant of a recycling chain associated with the physical product, such as described in the context of FIG. 8A. The decentral network participant may be associated with an account of distributed ledger network 224. Each account may be associated with at least one unique address. The account and hence also the address may uniquely identify the decentral network participant within the decentral participant network 1130.

The participant(s) of the decentral participant network 1130 may be connected via a material flow 1132 as described in the context of FIG. 8A.

At least part of the participants of the decentral participant network 1130 may be associated with decentral participant network nodes 1110 to 1124. The decentral participant nodes 1110 to 1124 may form distributed ledger network 224. Distributed ledger network 220 may be a peer-to-peer network. The peer-to-peer network may not comprise a central instance and/or third-party organization. Each node 1110 to 1124 of peer-to-peer network 224 and/or each participant 104, 106, 108, 112, 114, 1102, 1106 and 1108 may be connectable at least to every other node of peer-to-peer network 224 and/or participant of decentral participant network 1130. For instance, at least one physical standard network (wired and/or wireless) may be used for connection. For communicating via the at least one physical standard network suitable transceiver modules may be arranged in the respective entities/devices. Nodes 2002 to 2102 may have equal rights which may distinguishes them from a server-client structure.

Nodes 1110 to 1124 may comprise a peer-to-peer application. The same peer-to-peer application may be implemented on each node 1110 to 1124, e.g. each node may comprise the same content and the same code (including one or more executable means) may be executed on each node. The peer-to-peer application may preferably be a distributed ledger, such as a blockchain. The distributed ledger may be inspected by all participants 104, 106, 108, 112, 114, 1102, 1106 and 1108 of the peer-to-peer network 224. In one example, each of nodes 1110 to 1124 may store the (entire) distributed ledger, such as the blockchain. In another example, only part of the distributed ledger may be provided on a node (light node).

The peer-to-peer application may be configured to create token(s) linked to environmental attribute(s) associated with input materials. The peer-to-peer application may be configured to transfer token(s) linked to environmental attribute(s) associated with input materials between participants of the decentral network 1130.

Participants 104, 106, 108, 112, 114, 1102, 1106 and 1108 may run a peer-to-peer application on nodes 1110 to 1124. At least part of the participants 104, 106, 108, 112, 114, 1102, 1106 and 1108 may be connected with peer-to-peer network 224 via peer-to-peer modules. The peer-to-peer module may be configured to communicate at least with the peer-to-peer network 224, i.e. the nodes 1110 to 1124 of the peer-to-peer network 224. Hence, the peer-to-peer modules may be a participant of the peer-to-peer network 224. The peer-to-peer module may not comprise the peer-to-peer application. Such a peer-to-peer module may be configured to provide access to the peer-to-peer application, e.g. via an API (application programming interface). Such a peer-to-peer module (also a node or light node) may comprise a decentral application and at least an API. Hence, such a peer-to-peer module may have access or may be connected to a “gateway” running a node, such as node 1110 to 1124, of the peer-to-peer network (so called remote node). The peer-to-peer module may be configured to generate transaction data, for example as described in the context of FIG. 2 and FIG. 4A to FIG. 4C. The peer-to-peer module may be configured to sign the generated transaction data, for example with a private key associated with the respective participant of network 1130. The peer-to-peer module may be configured to provide generated transaction data to peer-to-peer network 224 for processing. The peer-to-peer module may be configured to query peer-to-peer network 224 for data. For instance, the peer-to-peer module may be configured to retrieve data from peer-to-peer network 224, such as token units stored in one or more addresses associated with the peer-to-peer module (e.g. addresses of the respective participant running the peer-to-peer module).

The peer-to-peer network 224 may be configured to perform data transactions 1134. Such data transactions 1134 may be associated with material flows 1132 between participants of the decentral participant network 1130. Data transactions 1134 may include data transactions between peer-to-peer modules and the peer-to-peer network 224. For instance, peer-to-peer modules may be configured to generate transaction data and provide the generated transaction data to peer-to-peer network 224. The transaction data may be associated with the creation of one or more token(s) as described in the context of FIG. 2 and FIG. 4A. The transaction data may be associated with the transfer of token units as described in the context of FIG. 4B and FIG. 4C. Data transactions 1134 may include data transactions between peer-to-peer nodes 1110 to 1124. For instance, a data transaction received by a node of peer-to-peer network 224 may be broadcasted to at least part of the other nodes of peer-to-peer network 224. Each transaction provided to peer-to-peer network 224 may contain a signature. For instance, the transaction data may be signed using a private key associated with the respective participant of network 1130. Prior to processing a transaction, the transaction may be validated by checking the signature of the transaction for example by comparing the signature with valid signatures stored e.g. in the peer-to-peer application. A part of nodes 1110 to 1124 may conduct the validation process. If the transaction is valid, it may be further processed, for example it may be included in a further block of the blockchain. It shall be understood that other means than signatures (e.g. communication addresses, certificates, etc.) may be used for a validation process or authentication process, respectively.

The peer-to-peer application may be a block chain. However, the following remarks can be easily transferred to other peer-to-peer applications, such as a Directed Acyclic Graph (DAG). A directed acyclic graph, such as IOTA or Tangle, means that blocks (or nodes of the graph) are coupled to each other via directed edges. Thereby, direct means that the (all) edges have (always) a same direction similar to time. In other words, it is not possible to step back. Eventually, acyclic means that loops do not exist.

The block chain may be a permissionless or permissioned block chain. The block chain may be a public, a consortium or a private block chain. The peer-to-peer application may be formed with multiple block chains which are connected via mechanisms, such as side chains or smart contracts. Interoperability among block chains may be established.

The block chain may be formed by at least two interconnected blocks. The first block may also be called genesis block. Each block (except for the first block) may refer to each previous block. A new block may be created by a computationally intensive process (for example, so called “mining” or through another appropriate process, such as voting) and will be particularly provided to all nodes 2002 to 2102 of the peer-to-peer network.

The block chain may be configured to receive transactions, such as transactions associated with creation of token(s) linked to environmental attributes associated with input materials and/or transactions associated with the transfer of token units linked to such environmental attributes. The transactions may be received from a peer-to-peer module as previously described. The block chain may be configured to validate received transactions. The block chain may be configured to save transactions, such as validated transactions, in new blocks of the block chain. For instance, the new block may be appended to existing blocks of the block chain. The block chain may at least be configured to control and manage environmental attributes associated with input materials, for example as described in the context of FIG. 1, FIG. 2, FIG. 4A, FIG. 4B and FIG. 4C.

In particular, a (newly) received transaction may be validated, saved and published in the current block of the block chain. The published transaction may be ready by at last part of the participants of the peer-to-peer network. Alternatively or additionally, data of a transaction may be stored in a registry storage e.g. on a decentral file service or distributed block chain database controlled by the block chain.

Only a part of the entire nodes of peer-to-peer network 224 may be configured to store the peer-to-peer application and/or only a part of the nodes of peer-to-peer network 224 may be configured to execute the algorithms of a smart contracts. Since the validation/verification requires a considerable computational effort, it may be advantageous for reasons of efficiency, if only a part of the nodes 1110 to 1124 perform the execution of executable means and/or validation algorithm(s) and/or authentication algorithm(s).

Validation, analytics and optimization may be done on-chain or off-chain, as described hereinbefore. Off-chain validation, analysis and/or optimization can be managed by the peer-to-peer application, like the code on the block chain. Powerful means, in particular, a high computing power. In other words, a valid entry in the peer-to-peer application, such as a block chain, is assumed if (only) a part of the peers 1110 to 1124 come to a positive result. It shall be understood that only a single, especially particularly powerful peer can perform the validation, analytics and/or optimization process while further nodes may be configured as monitoring nodes.

Similarly, in a further (not shown) embodiment, a particularly large peer-to-peer network may be divided in two or more clusters. In a corresponding peer-to-peer network, for example, a validation may only be carried out by the members of one cluster (e.g. sharding of a block chain to improve the scalability). In a further embodiment, the peer-to-peer application may be formed using multiple block chains. These block chains are connected via frameworks such as sidechains or smart contracts or interledger.

FIG. 11B illustrates a transfer of token units linked to environmental attribute(s) associated with vegetable oil(s) from a first chemical product producer via a platform to a second chemical product producer.

Chemical product producer 104 may operate a chemical production network, such as chemical production network 206 described in the context of FIG. 2, and may produce chemical products using one or more vegetable oil(s) provided as inputs to 206. At least part of the vegetable oil(s) may be associated with environmental attributes as described in the context of FIG. 1. Upon entry of such vegetable oil(s), the operating system, such as operating system 202, associated with the chemical production network, may tokenize one or more of the environmental attributes, such as described in the context of FIG. 2. Units of token(s) resulting from said tokenization may be allocated to produced chemical products, for example as described in the context of FIG. 4A to FIG. 4C.

Chemical product producer 104 may transfer unused or remaining units of token(s) linked to environmental attributes associated with vegetable oil(s) 116 to environmental attributes platform 114. For instance, operating system 202 associated with chemical product producer 104 may be configured to generate transaction data and to provide the transaction data to a distributed ledger network. The distributed ledger network may be distributed ledger network 224 of FIG. 11A. The transaction data may be provided via node 1112 associated with chemical product producer 104 to the distributed ledger network. The transaction data may include the address associated with environmental attributes platform 114 and the units of token(s) 116 to be transferred. Upon processing of the transaction by the distributed ledger network, the units of token(s) may be assigned to an address associated with environmental attributes platform 114 (e.g. may be deducted from the address associated with chemical product producer 104 and assigned to the address associated with environmental attributes platform 114).

Chemical product producer 2 112 may provide a request to the entity operating environmental attributes platform 114. The request may include the units of token(s) 122 to be transferred and the address associated with chemical product producer 2 112. The request may be provided to environmental attributes platform 114. The request may generate transaction data to initiate transfer of the requested units of token(s) to the given address. The request may be provided via node 1118 associated with chemical product producer 2 112 to environmental attributes platform 114. Environmental attributes platform 114 may be associated with node 1114 of distributed ledger network 224. Environmental attributes platform 114 may be configured to generate the transaction data to transfer the requested token units. Upon processing of the transaction, the requested units of token(s) 122 may be transferred from an address associated with environmental attributes platform 114 to an address associated with chemical product producer 2 112. Chemical product producer 2 112 may then use the acquired units of token(s) to allocate them to produced chemical products, for example as described in the context of FIG. 9 and FIG. 10.

FIG. 11C illustrates an exchange of token(s) linked to environmental attributes and being associated with a chemical product provided by the chemical production network to a chemical product consumer via a decentral peer-to-peer network.

Chemical product producer 104 may produce one or more chemical products using vegetable oil(s) associated with environmental attributes, for example as described in the context of FIG. 1 and FIG. 2. Upon entry of the vegetable oil(s) to the chemical production network, the operating system associated with said chemical production network may tokenize one or more of said environmental attributes, for example as described in the context of FIG. 2. Tokenized environmental attribute(s) may be assigned to the produced chemical products, for example as described in the context of FIG. 4A to FIG. 4C. For example, assigning environmental attribute(s) to produced chemical products may include generating a non-fungible token, for example as described in the context of FIG. 4A. The non-fungible token may be generated by a third party on behalf of the entity operating the chemical production network producing the polyamide (see for example FIG. 4A). The non-fungible token may comprise data, such NFT data 1142. The NFT data 1142 may be recorded in the distributed ledger and may include the chemical product identifier, a batch ID, an order ID and the environmental attribute (e.g. 100% sustainable palm oil content). The NFT data 1142 may be linked with further metadata, for example via a pointer contained in the NFT data 1142 (not shown). Such further metadata may be stored off-chain. Such further metadata may include a code printed on the packaging of the chemical product. Such metadata may include safety data sheets and/or technical data sheets and or further documents associated with the transport of a chemical product. Such further metadata may be accessed via the NFT.

The non-fungible token may be owned by chemical product producer 104 as signified by a transaction creating said NFT at the address associated with the chemical product producer 104 or transferring said NFT to the address associated with the chemical product producer 104 (see FIG. 4A). The transaction may be stored in a block of the peer-to-peer network 224.

The chemical product 118 as produced by chemical product producer 104 may be provided in association with the NFT to chemical product consumer 106. Upon providing the chemical product 118 to chemical product consumer 106, chemical product producer 104 may generate transaction data to transfer to NFT associated with said chemical product 118 to chemical product consumer 106. The transaction data may be generated by a peer-to-peer module associated with chemical product producer 104. The transaction data may include the address associated with the chemical product consumer 106 as well as data being indicative of the NFT to be transferred. The transaction data may be signed by a private key associated with chemical product producer 104. The transaction data may be provided to the peer-to-peer network 224, such as node 1112. Peer-to-peer network 224 may validate the received transaction as described in the context of FIG. 11A. Peer-to-peer network 224 may store the received transaction in a new block of the block chain. Upon storing the received transaction in a new block of the block chain, ownership of the NFT has been transferred from chemical product producer 104 to chemical product consumer 106.

Chemical product consumer 106 may use the NFT data 1142 to assign environmental attribute(s) associated with products produced using the chemical product 118 to such products. Assignment of such attribute(s) may include generating a further NFT as described in the context of FIG. 4A. The further NFT may be associated with NFTs of chemical product(s) used to produce the product. For instance, the further NFT may contain a link or pointer to such NFTs.

This way the environmental attributes of input materials, chemical products and any products produced from chemical products may be tracked through the value chain up to the end product. By tracking the environmental attributes of materials in such way the information can be made transparent across the value chain while the information flow can be controlled by the participants in the supply chain. Overall, such tracking enables tracking of positive environmental impact by individual supply chain participants, which makes positive environmental impacts transparent and attributable to individual supply chain participants.

The present disclosure has been described in conjunction with preferred embodiments and examples as well. However, other variations can be understood and effected by those persons skilled in the art and practicing the claimed invention, from the studies of the drawings, this disclosure and the claims.

Any steps presented herein can be performed in any order. The methods disclosed herein are not limited to a specific order of these steps. It is also not required that the different steps are performed at a certain place or in a certain computing node of a distributed system, i.e. each of the steps may be performed at different computing nodes using different equipment/data processing.

As used herein “determining” also includes “initiating or causing to determine”, “generating” also includes “initiating and/or causing to generate” and “providing” also includes “initiating or causing to determine, generate, select, send and/or receive”. “Initiating or causing to perform an action” includes any processing signal that triggers a computing node or device to perform the respective action.

In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

Any disclosure and embodiments described herein relate to the methods, the systems, devices, the computer program element lined out above and vice versa. Advantageously, the benefits provided by any of the embodiments and examples equally apply to all other embodiments and examples and vice versa.

All terms and definitions used herein are understood broadly and have their general meaning.

Any disclosure and embodiments described herein are mere examples for implementing the method, the system or application device disclosed herein and shall not be considered limiting.

1. A method for producing a chemical product associated with at least one environmental attribute, wherein the chemical product is produced by a chemical production using one or more vegetable oils(s) as input material, the method comprising:
receiving units of token(s) linked to one or more environmental attributes associated with the one or more of the vegetable oil(s) at an address associated with a distributed ledger, wherein the address is associated with the operating system of the chemical production;
producing the chemical product at least in part from the one or more vegetable oil(s) with the chemical production;
providing a chemical product identifier associated with the chemical product and optionally at least one target environmental attribute;
based on the chemical product identifier and optionally the target environmental attribute, selecting at least one attribution rule for attributing token(s) linked to one or more environmental attributes(s) associated with vegetable oil(s) to chemical product(s);
determining via the at least one attribution rule units of token(s) linked to one or more environmental attribute(s);
assigning the determined units of token(s) linked to the one or more environmental attribute(s) to the chemical product identifier; and
providing the chemical product associated with the units of token(s).

2. The method of claim 1, wherein the vegetable oil is selected from palm oil, palm kernel oil, coconut oil or combinations thereof.

3. The method of claim 1, wherein the environmental attribute is associated with production data of the vegetable oil.

4. The method of claim 3, wherein the production data includes data associated with the growth of the plants used to produce the vegetable oil, data associated with the harvesting of the plants used to produce the vegetable oil, data associated with the transport of harvested plants or parts thereof, data associated with the processing of the harvested plants or parts thereof, data associated with the refining of vegetable oil, or a combination thereof.

5. The method of claim 1, wherein the environmental attribute is associated with or corresponds to certificate data being indicative of a production of the vegetable oil according to predefined production criteria.

6. The method of claim 1, wherein the units of token(s) are received in response to a request, said request including the address and the units of token(s).

7. The method of claim 1, wherein the received units of token(s) are created upon use of vegetable oil(s) associated with the environmental attribute(s) within a different chemical production to produce chemical product(s) and are not assigned to a chemical product produced by said different chemical production.

8. The method of claim 1, wherein the environmental attributes associated with the one or more of the vegetable oil(s) are decoupled from the physical flow of vegetable oil(s) within the chemical production.

9. The method of claim 1, wherein the at least one attribution rule is associated with the vegetable oil(s) characterized by at least one environmental attribute type.

10. The method of claim 1, wherein the at least one attribution rule may include instructions to determine vegetable oil(s) used to produce the chemical product.

11. The method of claim 1. wherein assigning units of the at least one of the tokens to the chemical product identifier comprises generating transaction data and providing the generated transaction data to the distributed ledger for creating one or more further token(s) specifying retired units of the token(s), the one or more environmental attributes linked to the token(s) and the provided chemical product identifier.

12. A system for producing a chemical product associated with at least one environmental attribute, the system comprising:
a chemical production configured to produce the chemical product using one or more vegetable oils(s) as input material and to provide the produced chemical product,
a distributed ledger application configured to receive units of token(s) linked to one or more environmental attributes associated with the one or more of the vegetable oil(s) at address associated with a distributed ledger, wherein the address is associated with the operating system of the chemical production,
an attribution module configured to provide at least one attribution rule for attributing token(s) linked to one or more environmental attributes(s) associated with vegetable oil(s) to chemical product(s);
a data provider configured to provide at least one chemical product identifier associated with the chemical product and optionally at least one target environmental attribute for the chemical product; and
an outbound allocator configured to
select based on the chemical product identifier and optionally the target environmental attribute at least one attribution rule,
determine via the at least one attribution rule units of token(s) linked to one or more environmental attribute(s), and
assign units of at least one of the tokens linked to the one or more environmental attribute(s) to the chemical product identifier.

13. A digital operating system of a chemical production, wherein the chemical production produces a chemical product using one or more vegetable oils(s) as input material, the digital operating system comprising:
a distributed ledger application configured to receive units of token(s) linked to one or more environmental attributes associated with the one or more of the vegetable oil(s) at address associated with a distributed ledger, wherein the address is associated with the operating system of the chemical production,
an attribution module configured to provide at least one attribution rule for attributing token(s) linked to one or more environmental attributes(s) associated with vegetable oil(s) to chemical product(s);
a data provider configured to provide at least one chemical product identifier associated with the chemical product and optionally at least one target environmental attribute for the chemical product; and
an outbound allocator configured to
select based on the chemical product identifier and optionally the target environmental attribute at least one attribution rule,
determine via the at least one attribution rule units of token(s) linked to one or more environmental attribute(s), and
assign units of at least one of the tokens linked to the one or more environmental attribute(s) to the chemical product identifier.

14. A computer element, optionally a computer program product or a computer readable medium, with instructions, which when executed by a processor cause the digital operation system of claim 13 to perform the steps of:
receiving units of token(s) linked to one or more environmental attributes associated with the one or more of the vegetable oil(s) at address associated with a distributed ledger, wherein the address is associated with the operating system of the chemical production;
providing a chemical product identifier associated with a chemical product produced by a chemical production associated with the digital operation system using one or more vegetable oil(s) as input materials, and optionally at least one target environmental attribute;
based on the chemical product identifier and optionally the target environmental attribute, selecting at least one attribution rule for attributing token(s) linked to one or more environmental attributes(s) associated with vegetable oil(s) to chemical product(s);
determining via the at least one attribution rule units of token(s) linked to one or more environmental attribute(s);
assigning the determined units of token(s) linked to the one or more environmental attribute(s) to the chemical product identifier;
providing the chemical product associated with the units of token(s).

15. A method to produce at least one discrete product or at least one end product of a product supply chain associated with one or more environmental attribute(s) comprising using a chemical product associated with one or more environmental attribute(s) as provided by the method of claim 1.
